(19) United States
(12) Patent Application Publication
(10) Pub. No.: US 2025/0367668 A1
(43) Pub. Date: Dec. 4, 2025

(54) EVAPORATIVE CONTROL LID FOR MULTI-WELL SAMPLE TRAYS COMPRISING A POROUS, WETTABLE, FREE-STANDING MATERIAL

(71) Applicant: Sartorius BioAnalytical Instruments, Inc., Bohemia, NY (US)

(72) Inventors: Colin Crawford, Oakland, CA (US); Thang Ung, San Ramon, CA (US)

(73) Assignee: Sartorius BioAnalytical Instruments, Inc., Bohemia, NY (US)

(21) Appl. No.: 19/301,377

(22) Filed: Aug. 15, 2025

Related U.S. Application Data
(63) Continuation-in-part of application No. 17/721,877, filed on Apr. 15, 2022, now Pat. No. 12,409,454.

(51) Int. Cl. B01L 3/00

(52) U.S. Cl. CPC B01L 3/50853; B01L 2200/142; B01L 2300/046; B01L 2300/12

(57) ABSTRACT

A cover configured to reduce evaporation from a multi-well sample tray while permitting sampling of material housed in separate wells of the tray. The cover may directly engage the sample tray and move with the sample tray or the cover may be stationary while permitting movement of the sample tray relative to the cover.

### RELATED APPLICATIONS

This application is a continuation-in-part of U.S. patent application Ser. No. 17/721,877, filed Apr. 15, 2022, and entitled “Evaporative Control Lid for Multi-Well Sample Trays,” which is incorporated herein by reference in its entirety for all purposes.

### BACKGROUND

Bio-layer interferometry (BLI) is an analytical technique commonly used to measure biomolecular interactions. BLI analysis commonly uses a multi-well sample tray with each well containing a biomolecule in a suitable liquid. A typical multi-well sample tray 2 has a plurality of regularly spaced sample wells 4 arranged in a rectangular configuration. In most configurations, sample tray 2 rests on a shaker or other device which provides movement sufficient to maintain the material 6 within sample wells 4 in the form of a suspension. Due to the continuous movement of sample tray 2 and the small sample size, evaporative loss of liquid material 6 from sample wells 4 sometimes occurs leading to a decrease in accuracy of the BLI analysis. See for example FIG. 10. Therefore, a multi-well sample tray evaporation control cover which precludes or limits evaporative loss from the sample tray 2 will enhance the accuracy of the BLI analysis. Preferably, the evaporation control cover will achieve this goal while permitting BLI analysis without removal of the evaporation control cover and while permitting continuous movement of the multi-well sample tray.

### SUMMARY

In one embodiment the present invention provides an evaporation control cover for use with a multi-well sample tray. The multi-well sample tray has a plurality of regularly spaced sample wells as defined by an outer perimeter of sample wells, with additional sample wells located within the outer perimeter of sample wells. The evaporation control cover comprises a plurality of sample holes arranged to correspond to the plurality of sample wells. The sample holes are defined by an outer perimeter of holes with additional sample holes located within the outer perimeter of holes. Optionally, a fluid port located in the cover provides fluid communication through the cover. The sample holes located within the outer perimeter of holes have a first diameter while the sample holes forming the perimeter holes have a second diameter which is less than or equal to the first diameter. The evaporation control cover carries a downwardly projecting flange configured to fit over the multi-well tray.

In an alternative embodiment, the present invention provides an evaporation control cover for use with a multi-well sample tray. The multi-well sample tray has a plurality of regularly spaced sample wells defined by an outer perimeter of sample wells with additional sample wells located within said outer perimeter of sample wells. The evaporation control cover comprises a top. The top includes a plurality of sample holes corresponding to the plurality of sample wells. Additionally, the top carries a downwardly projecting flange configured to fit over the multi-well tray. The cover also includes a bottom. The bottom has a plurality of upwardly projecting ports providing fluid communication through the bottom. The upwardly projecting ports configured to correspond to said plurality of sample wells. The bottom carries an upwardly projecting flange configured to fit within the downwardly projecting flange of the top. The upwardly projecting flange and the upwardly projecting ports define a reservoir suitable for retaining a liquid. Further, the upwardly projecting ports provide fluid communication between the sample holes and the sample wells. This embodiment may optionally include a wettable insert capable of absorbing and releasing a liquid. The wettable insert has a plurality of insert holes corresponding to said plurality of sample wells.

In another alternative embodiment, the present invention provides an evaporation control cover for use with a multi-well sample tray. The multi-well sample tray has a plurality of regularly spaced sample wells arranged in a rectangular configuration as defined by a first outer perimeter row, a second outer perimeter row, a third outer perimeter row and a fourth outer perimeter row. The outer perimeter rows defining the rectangular configuration have a first corner well, a second corner well, a third corner well and a fourth corner well with additional rows of sample wells located within the rectangular configuration. The evaporation control cover comprises a top. The top includes a plurality of sample holes arranged in a rectangular configuration corresponding to the plurality of sample wells and defined by a first top outer perimeter row, a second top outer perimeter row, a third top outer perimeter row and a fourth top outer perimeter row. The top outer perimeter rows defining the rectangular configuration further include a first top corner hole, a second top corner hole, a third top corner hole and a fourth top corner hole with additional rows of sample holes located within the rectangular configuration. The sample holes located to the interior of the first top outer perimeter row, the second top outer perimeter row, the third top outer perimeter row and the fourth top outer perimeter row have a first diameter. The sample holes within the first top outer perimeter row, the second top outer perimeter row, the third top outer perimeter row and the fourth top outer perimeter row have a second diameter which is less than or equal to the first diameter. Additionally, the top carries a downwardly projecting flange configured to fit over the multi-well tray. The cover also includes a bottom. The bottom has a plurality of upwardly projecting ports providing fluid communication through the bottom. The upwardly projecting ports have a rectangular configuration corresponding to the plurality of sample wells. The rectangular configuration is defined by a first bottom outer perimeter row, a second bottom outer perimeter row, a third bottom outer perimeter row and a fourth bottom outer perimeter row. The bottom outer perimeter rows defining the rectangular configuration have a first corner upwardly projecting port, a second corner upwardly projecting port, a third corner upwardly projecting port and a fourth corner upwardly projecting port. Additional rows of upwardly projecting ports are located within the rectangular configuration. The bottom carries an upwardly projecting flange configured to fit within the downwardly projecting flange of the top. The upwardly projecting flange and the upwardly projecting ports define a reservoir suitable for retaining a liquid. Further, the upwardly projecting ports provide fluid communication between the sample holes and the sample wells. This embodiment may optionally include a wettable insert capable of absorbing and releasing a liquid. The wettable insert has a plurality of insert holes in a rectangular configuration corresponding to said plurality of sample wells.

In some embodiments, an evaporation control cover for use with a multi-well sample tray comprising a plurality of sample wells is provided. The evaporation control cover comprises a porous, wettable, free-standing material. The porous, wettable, free-standing material comprises a plurality of pores. The porous, wettable, free-standing material comprises one or more sample holes. The one or more sample holes are arranged such that, when the evaporation control cover is in use, each sample well is beneath and vertically accessible by a sample hole. The sample hole or holes are larger than the pores.

In some embodiments, an evaporation control cover for use with a multi-well sample tray comprising a plurality of sample wells is provided. The evaporation control cover comprises a porous, wettable, free-standing material. The porous, wettable, free-standing material comprises a plurality of pores. The porous, wettable, free-standing material comprises a plurality of sample holes arranged to correspond to the sample wells. The sample holes are larger than the pores.

### BRIEF DESCRIPTION OF THE DRAWINGS

FIG. 1 provides a perspective view of one embodiment of the multi-well sample tray evaporation control cover.

FIG. 2 provides an exploded view of the evaporation control cover of FIG. 1.

FIG. 3 provides a cut-away view along line 3-3 of FIG. 1 showing gap A and the multiple layers making up the evaporation control cover of FIGS. 1 and 2.

FIG. 4 provides a partial cut-away perspective view depicting an embodiment of the evaporation control cover as installed on a multi-well tray where the evaporation control cover moves with the multi-well tray.

FIG. 5 provides a partial cut-away perspective view depicting another embodiment of the evaporation control cover where the evaporation control cover remains stationary while the multi-well tray moves beneath the evaporation control cover.

FIG. 6 depicts an analytical probe passing through the embodiment of FIG. 4 into a sample well.

FIG. 7 depicts an analytical probe passing through another embodiment of the evaporation control cover where the evaporation control cover lacks a bottom and a wettable insert, and the evaporation control cover remains stationary.

FIG. 8 depicts a partial cut-away perspective view depicting the embodiment of FIG. 7.

FIG. 9 depicts a partial cut-away perspective view depicting another embodiment of the evaporation control cover as installed on a multi-well tray where the evaporation control cover moves with the multi-well tray.

FIG. 10 depicts a prior art view of an analytical probe positioned within a well of a multi-well tray lacking an evaporation control cover.

FIG. 11 shows one non-limiting example of a top view of an exemplary porous, wettable, free-standing material.

FIG. 12 shows a side view of the porous, wettable, free-standing material disposed on a multi-well sample tray.

FIG. 13 shows a porous, wettable, free-standing material that includes a single sample hole.

FIG. 14 shows a porous, wettable, free-standing material that includes two sample holes.

FIG. 15 shows a porous, wettable, free-standing material that includes a sample hole that comprises a slit that extends to an edge of the central body portion.

FIGS. 16-20 show porous, wettable, free-standing materials comprising flanges.

FIGS. 21-24 show porous, wettable, free-standing materials comprising tabs.

FIG. 25 shows a porous, wettable, free-standing material comprising a lip.

FIGS. 26-30 show porous, wettable, free-standing materials comprising ribs.

FIGS. 31-36 show porous, wettable, free-standing materials comprising embossments.

FIG. 37 shows a porous, wettable, free-standing material on which an adhesive is disposed.

FIG. 38 shows a porous, wettable, free-standing material on which a coating is disposed.

### DETAILED DESCRIPTION

The drawings included with this application illustrate certain aspects of the embodiments described herein. However, the drawings should not be viewed as exclusive embodiments. For simplicity and clarity of illustration, where appropriate, reference numerals may be repeated among the different figures to indicate corresponding or analogous elements and the drawings are not necessarily to scale. Throughout this disclosure, the terms “about”, “approximate”, and variations thereof, are used to indicate that a value includes the inherent variation or error for the device, system, the method being employed to determine the value, or the variation that exists among the study subjects. Finally, the description is not to be considered as limiting the scope of the embodiments described herein.

Some embodiments described herein relate to evaporation control covers for use with multi-well sample trays comprising a plurality of sample wells. Such evaporation control covers may have one or more features that reduce the rate and/or amount of evaporation from wells within the multi-well sample tray.

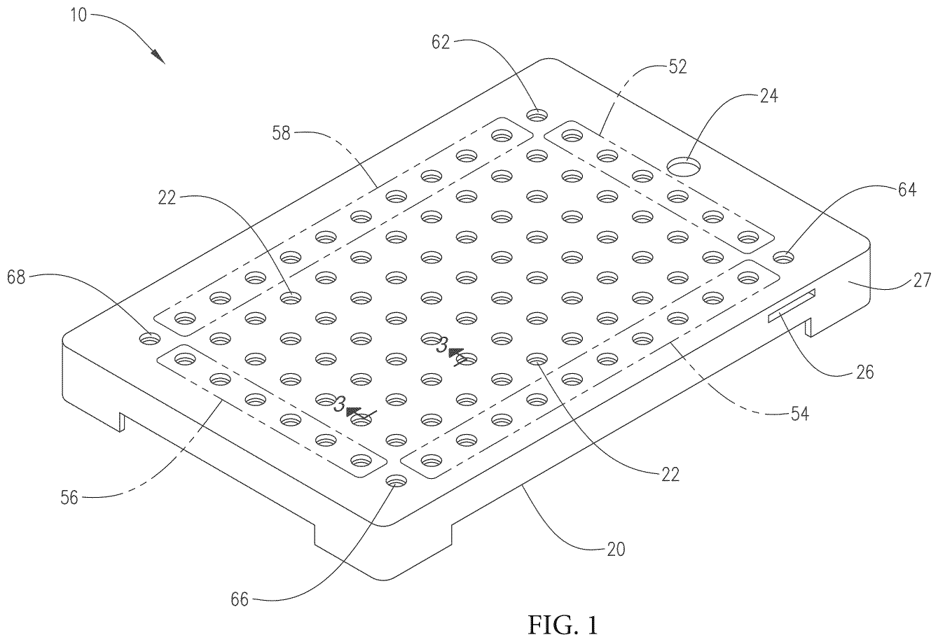

FIGS. 1-9 depict embodiments of the evaporation control cover 10. As depicted, evaporation control cover 10 is particularly adapted for use with a multi-well sample tray 2 having sample wells 4. A typical multi-well sample tray 2 has 96 sample wells 4. Of course, the configuration of evaporation control cover 10 may be modified to accommodate multi-well sample trays 2 of differing configurations. In some embodiments, an evaporation control cover described herein is suitable for use with a 384-well tray.

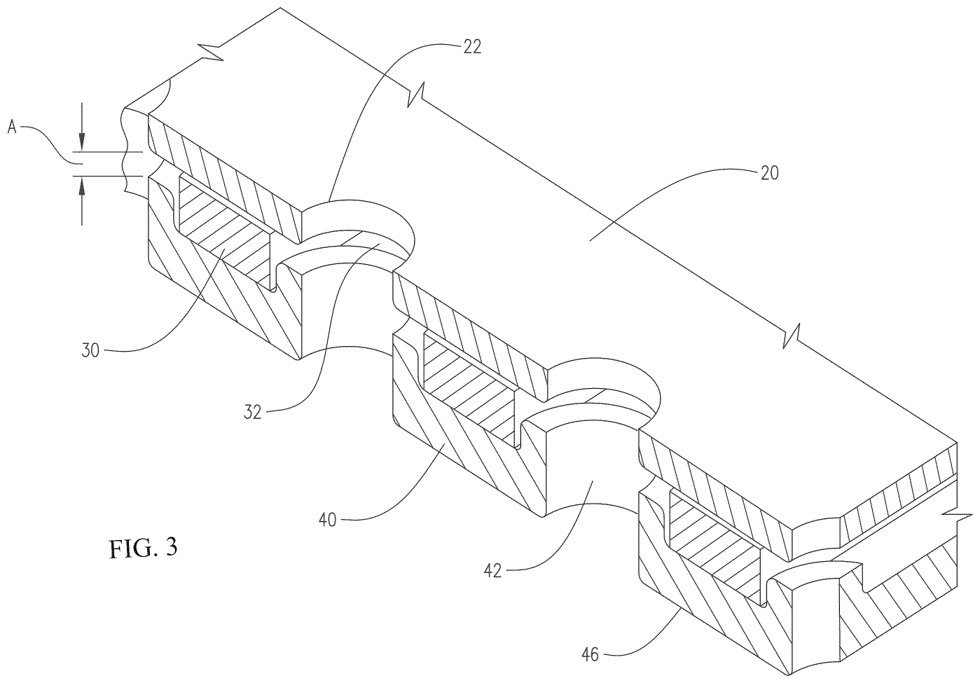

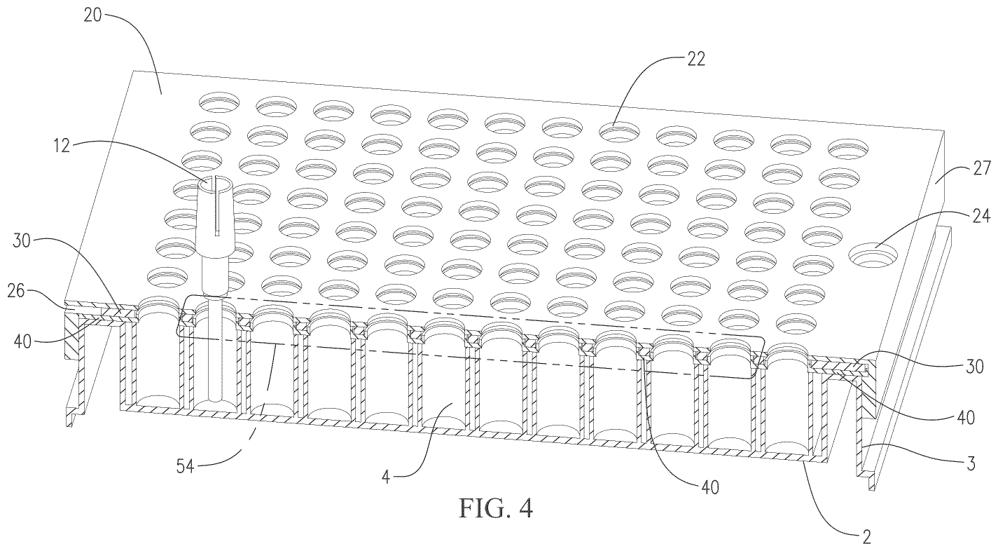

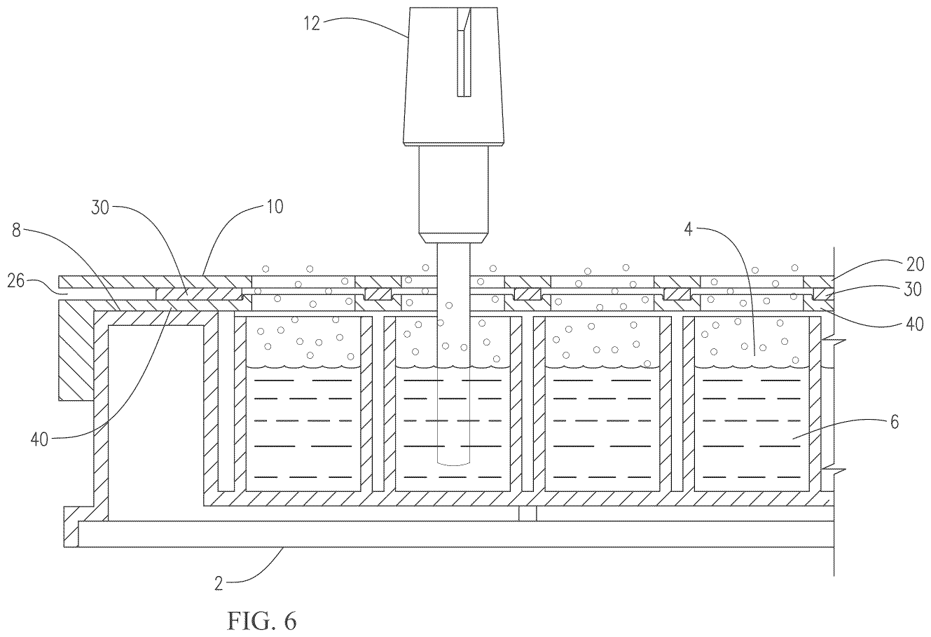

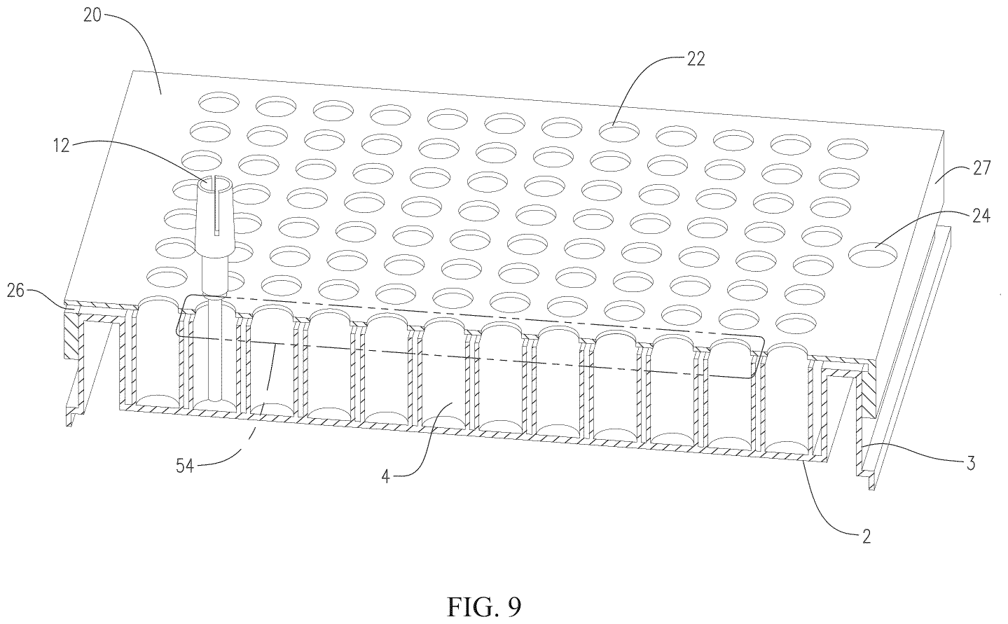

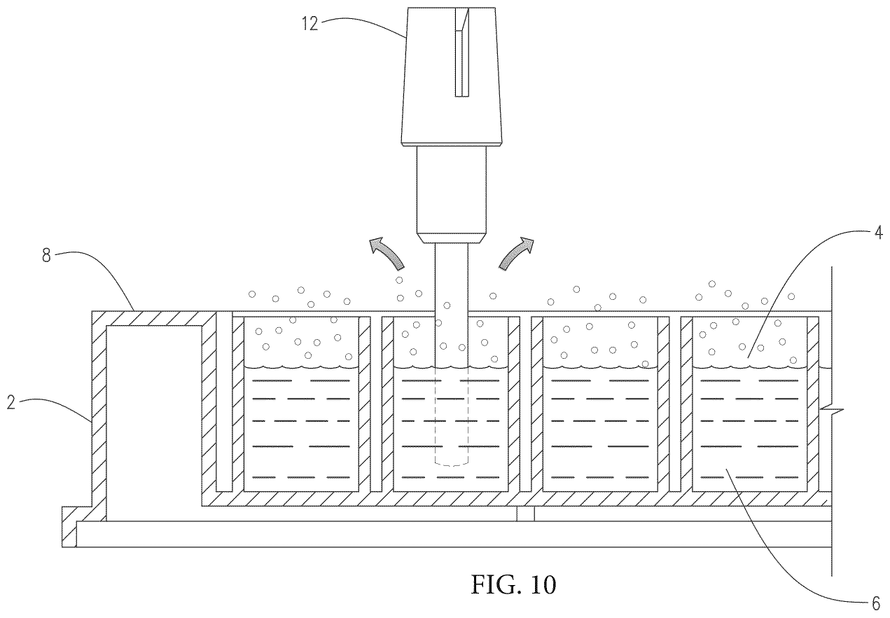

As depicted in FIG. 4, evaporation control cover 10 may be configured to engage sample tray 2 and thereby move with sample tray 2. In one embodiment, the design of evaporation control cover 10 may provide a close engagement with sample tray 2. For example, evaporative control cover 10 may be configured to provide a frictional or snap fit securement to sample tray 2. FIGS. 6 and 9 depict examples where cover 10 nests over and engages sample tray 2. Typically, when evaporation control cover 10 engages sample tray 2, holes 22 remain in a consistent aligned position over sample wells 4.

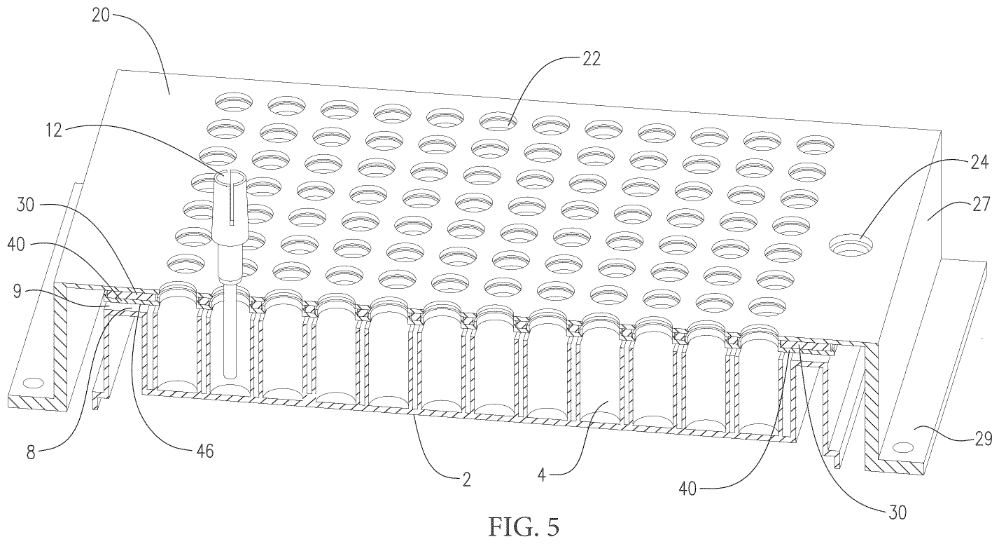

Alternatively, evaporation control cover 10 may be configured to permit movement of sample tray 2 while evaporation control cover 10 remains stationary. As depicted in FIGS. 5, 7 and 8 evaporation control cover 10 may be configured to permit securement of evaporation control cover 10 to a surface outside of the region supporting multi-well sample tray 2. In this configuration, evaporation control cover 10 may touch the upper surface of multi-well sample tray 2 so long as the contact does not inhibit the movement of multi-well sample tray 2. More typically, a slight gap 9 sufficient to permit movement of the multi-well sample tray 2 relative to control cover 10 will be provided between the upper surface 8 of multi-well sample tray 2 and the lower surface 46 of evaporation control cover 10. Typically, the gap will be between about 0.1 mm and about 1.0 mm. Thus, gaps of 0.2 mm, 0.3 mm, 0.4 mm, 0.5 mm, 0.6 mm, 0.7 mm, 0.8 mm, and 0.9 mm will also be appropriate.

One embodiment of evaporation control cover 10 will be described with reference to FIGS. 1-6. As depicted therein, evaporation control cover 10 includes a top 20, a bottom 40 with a wettable insert 30 retained between top 20 and bottom 40. The combination of top 20, wettable insert 30, and bottom 40 cooperate to reduce or preclude the loss of liquid from sample wells 4.

Without wishing to be bound by theory, the addition of liquids to wettable insert 30 is believed to enhance the functionality of evaporative control cover 10. Wettable insert 30 may have a thickness greater than Distance A depicted in FIG. 3. Distance A corresponds to the gap between the upper surface of bottom 40 and the lower surface of top 20. Thus, in some embodiments wettable insert 30 may be compressed between top 20 and bottom 40, i.e., insert 30 has a thickness greater than Distance A. Typically, wettable insert 30 will have a thickness which is 1.59 mm. However, wettable insert 30 may have a thickness which is less than, equal to or greater than distance A as depicted in FIG. 3. Depending on the application of evaporative control cover 10, distance A may range from about 0.1 mm to about 2 mm, from about 0.25 mm to about 1.5 mm or from about 0.5 mm to about 1 mm. Wettable insert 30 may be prepared as a felt, a non-woven or a woven material from a wide variety of materials capable of holding a liquid. For example, felts may be prepared from polypropylenes and polyesters. Sponges prepared from silicone, polyester, polypropylene, and polyethylene are also suitable for use as wettable insert 30. Likewise, open-cell foams prepared from silicone, polyurethane or polyethylene are suitable. Alternatively, a blanket like material prepared from polyimides will suffice.

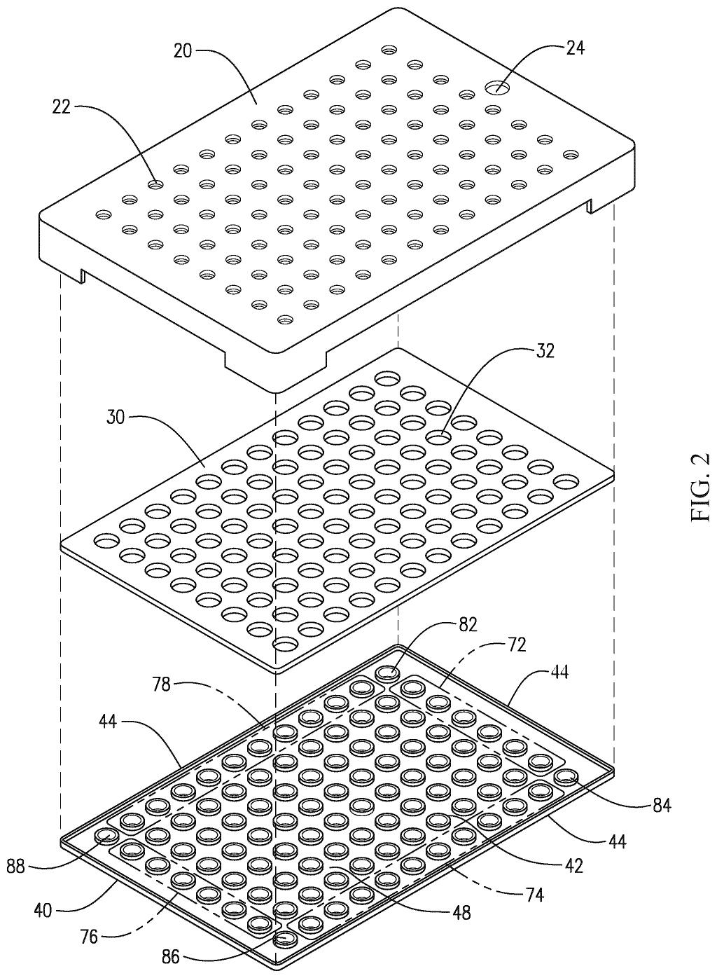

As depicted in FIGS. 1-2, 4-5, 8, and 9 cover 10 includes an optional fluid port 24. In the depicted embodiment of FIGS. 1-2 4-5, 8, and 9 fluid port 24 provides fluid communication through top 20 to the interior of evaporation control cover 10 including wettable insert 30 and bottom 40. However, port 24 may take other forms. For example, as depicted in FIGS. 1, 4, 6, and 9 an alternative opening 26 through top 20 allows access to either wettable insert 30 or reservoir 48 through which fluid may be added. Alternative opening 26 may be located at any convenient location on a side of top 20. While FIG. 1 depicts both opening 26 and port 24, typically only one of these two elements will be present. In most instances the liquid used to wet wettable insert 30 will be the same as the liquid used within sample wells 4 less the biological material being analyzed. However, any liquid which will not interfere with the analytical process, and which will produce a sufficient partial pressure above sample wells 4 may be used. Typically, the fluid used to wet wettable insert 30 will be added to evaporation control cover 10 through fluid port 24. Of course, prior to initial assembly of evaporation control cover 10, wettable insert 30 may be pre-wetted with the desired fluid.

The wettable insert 30 may be pre-wetted through a variety of techniques, such as by applying a seal (e.g., film) over the top 20 and/or bottom 40 of the cover 10 to contain the wettable insert 30; sealing the cover 10 with the wettable insert 30 in a bag; and/or positioning one or more plugs around the holes 32 of the wettable insert 30. The plugs may be made from a variety of materials, such as elastomer or plastic. Other techniques may also be used in other embodiments for pre-wetting the wettable insert 30 with the desired fluid.

In an alternative embodiment, wettable insert 30 may be replaced with any suitable solution used to wet wettable insert 30. Similarly, placing a saturated salt or other compatible solution in reservoir 48 will likely create a high humidity environment over the sample wells 4 sufficient to provide the desired reduction in evaporative loss from wells 4. For example, a potassium sulfate saturated water solution is known to create a 98% humidity above the solution.

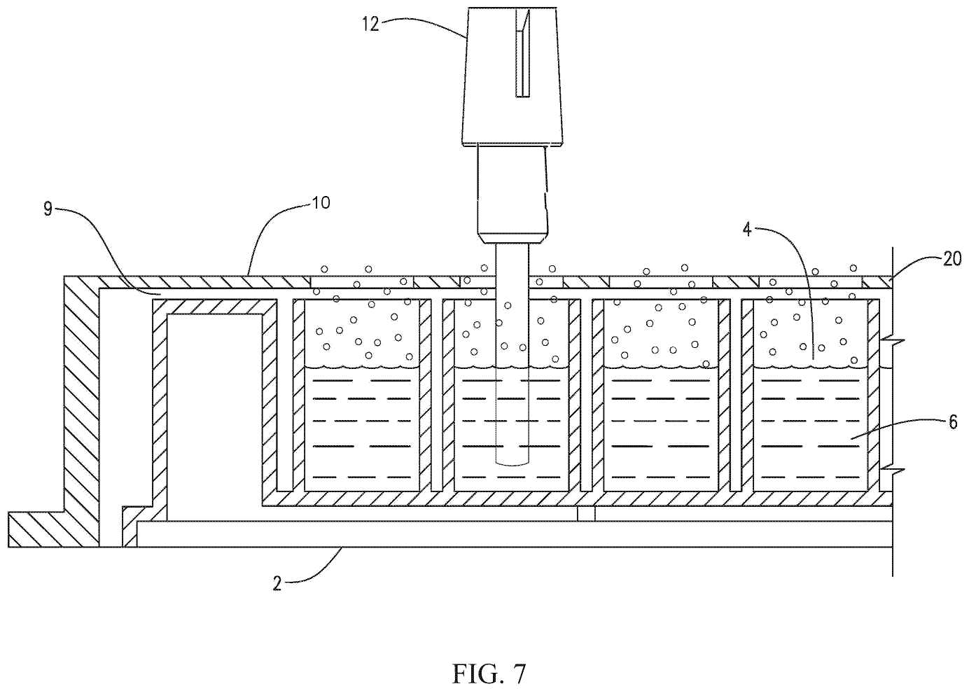

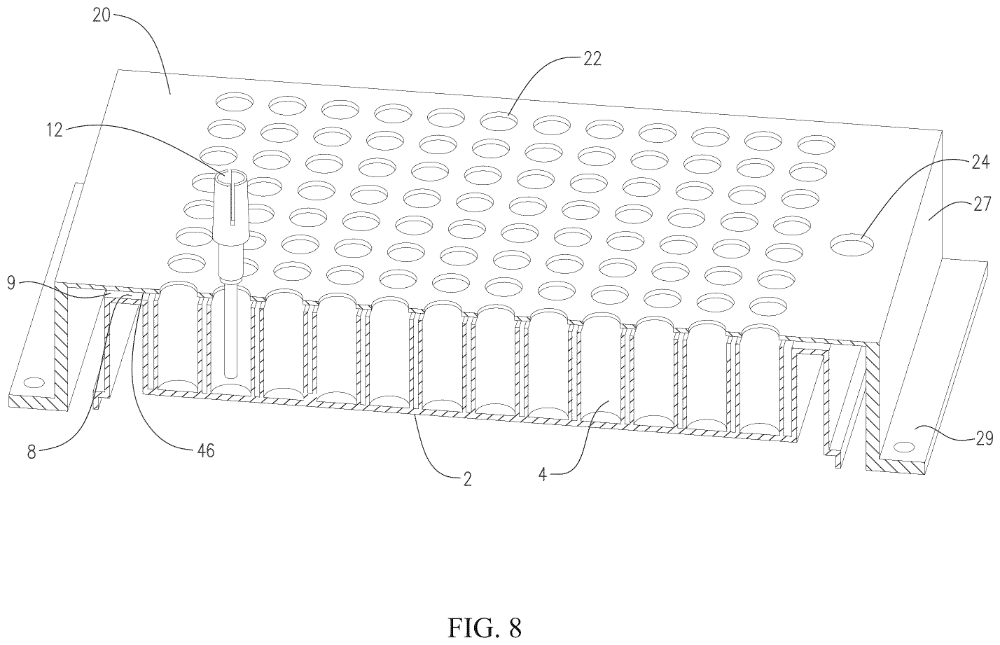

Top 20 includes a downwardly projecting flange 27. In the embodiment of FIGS. 4 6, and 9 downwardly projecting flange 27 engages the outer surface 3 of sample tray 2. In the embodiment of FIGS. 5, 7 and 8, downwardly projecting flange 27 further carries an outwardly projecting flange 29 suitable for supporting cover 10 or top 20 when top 20 is used alone as depicted in FIGS. 7-8.

Top 20 includes a plurality of holes 22 providing fluid communication through top 20. As depicted in FIGS. 1-2, 4-5, 8, and 9 holes 22 are arranged in a plurality of rows laid out in a rectangular fashion. Thus, holes 22 correspond in location to sample wells 4. The plurality of rows of holes 22 are defined by a first outer perimeter row 52, a second outer perimeter row 54, a third outer perimeter row 56 and a fourth outer perimeter row 58. Each outer perimeter row 52-58 shares a corner hole or location 62, 64, 66 and 68 with an adjacent perimeter row 52-58 as depicted in FIG. 1. Thus, top 20 is configured to correspond to the arrangement of a conventional plate of sample tray 2. Top 20 can be modified in configuration to accommodate alternative sample tray 2 configurations.

Through multiple observations, sample wells 4 in the perimeter of multi-well sample tray 2 were determined to experience a higher rate of evaporative fluid loss than sample wells 4 to the interior of multi-well sample tray 2. Therefore, to provide the desired evaporative control, holes 22 in top 20 have differing diameters based on their location. Holes 22 located to the interior of perimeter rows 52-58 have a first diameter (D1). Holes 22 within perimeter rows 52-58 have a second diameter (D2) which is less than the first diameter and corner holes 62, 64, 66 and 68 have a third diameter (D3). The third diameter is equal to or less than the second diameter. Thus, the diameters for each location can be stated as D1≥D2≥D3. The sizes of the first diameter, second diameter and third diameter will depend on the configuration of evaporation control cover 10.

When evaporation control cover 10 has a configuration similar to that of FIG. 4, i.e., evaporation control cover 10 engages sample tray 2 and moves with sample tray 2, then D1 may be between about 0.7 mm and about 5.9 mm. More typically, D1 may be between about 1.4 mm and about 4.8 mm. In most cases, D1 will be between about 1.7 mm and about 4.4 mm. In this configuration, D2 may be from 0.2 times D1 to 0.85 times D1 and D3 is from 0.15 times D1 to 0.7 times D1. For example, when D1 is 2.0 mm, D2 may be between 0.4 mm and 1.7 mm and D3 may be between 0.3 mm and 1.4 mm. More typically, D2 is from 0.3 times D1 to 0.8 times D1 and D3 is from 0.2 times D1 to 0.6 times D1. In most cases, D2 is from 0.4 times D1 to 0.7 times D1 and D3 is from 0.25 times D1 to 0.5 times D1.

When evaporation control cover 10 has a configuration similar to that of FIG. 5, i.e., evaporation control cover 10 is stationary with sample tray 2 moving beneath it, then D1 may be 0.5 mm and about 5.0 mm. More commonly, D1 may be between about 0.7 mm and about 4.5 mm. More typically, D1 will be between about 0.9 mm and about 3.9 mm. In this configuration, D2 may be from 0.2 times D1 to 0.85 times D1 and D3 is from 0.15 times D1 to 0.7 times D1. For example, when D1 is 2.0 mm, D2 may be between 0.4 mm and 1.7 mm and D3 may be between 0.3 mm and 1.4 mm. More typically, D2 is from 0.3 times D1 to 0.8 times D1 and D3 is from 0.2 times D1 to 0.6 times D1. In most cases, D2 is from 0.4 times D1 to 0.7 times D1 and D3 is from 0.25 times D1 to 0.5 times D1.

In some embodiments, the desired reduction in evaporation from sample wells 4 will be achieved when D2 is 50% of D1 and D3 is 33% of D1.

As depicted in FIGS. 2-3, bottom 40 includes a plurality of upwardly projecting ports 42. Ports 42 are aligned with holes 22. Ports 42 provide fluid communication through bottom 40. When in use, upwardly projecting ports 42 and holes 22 provide a passageway for a sensor probe 12 to pass through evaporation control cover 10 into selected sample well 4. Additionally, as depicted in FIGS. 2, 4-5, 8, and 9 upwardly projecting ports 42 are arranged in a plurality of rows laid out in a rectangular fashion corresponding to the rows of top 20. Thus, upwardly projecting ports 42 correspond in location to sample wells 4. The plurality of rows of upwardly projecting ports 42 are also defined by a first outer perimeter row 72, a second outer perimeter row 74, a third outer perimeter row 76 and a fourth outer perimeter row 78. Each outer perimeter row 72-78 shares a corner hole 82, 84, 86 and 88 with an adjacent perimeter row 72-78 as depicted in FIG. 2.

Bottom 40 carries an upwardly projecting flange 44. The region between upwardly projecting flange 44 and upwardly projecting ports 42 defines a reservoir 48. Reservoir 48 receives the wetting fluid through port 24 or alternatively through alternative opening 26 which permits fluid to pass between top 20 and bottom 40 into reservoir 48. Thus, liquid retained in reservoir 48 helps maintain wettable insert 30 sufficiently saturated to provide the desired evaporative control. Alternatively, as discussed above, reservoir 48 may be used to contain the desired liquid without the presence of wettable insert 30.

In some embodiments, upwardly projecting ports 42 in bottom 40 may have differing inside diameters based on their location. Upwardly projecting ports 42 located to the interior of perimeter rows 72-78 have a fourth inside diameter (D4). Upwardly projecting ports 42 within perimeter rows 72-78 have a fifth inside diameter (D5) which is less than or equal to the fourth diameter and corner holes 82, 84, 86 and 88 have a sixth inside diameter (D6). The sixth inside diameter is equal to or less than the fifth inside diameter. Thus, the diameters for each location can be stated as D4≥D5≥D6. The sizes of the fourth inside diameter, fifth inside diameter and sixth inside diameter will depend on the configuration of evaporation control cover 10. Upwardly projecting ports 42 also have outside diameters which may be from about 1 mm to about 3 mm greater than the corresponding inside diameters. When bottom 40 has ports 42 of differing sizes as outline above, top 20 may have holes 22 of uniform diameter. Likewise, when top 20 has holes 22 of differing sizes as previously defined, then bottom 40 may have projecting ports 42 of uniform diameter.

In most instances, D1 will equal D4, D2 will equal D5 and D3 will equal D6. Thus, when evaporation control cover 10 has a configuration similar to that of FIG. 4, i.e., evaporation control cover 10 engages sample tray 2 and moves with sample tray 2, then D4 may be between about 0.7 mm and about 5.9 mm. More typically, D4 may be between about 1.4 mm and about 4.8 mm. In most cases, D4 will be between about 1.7 mm and about 4.4 mm. In this configuration, D5 may be from 0.2 times D4 to 0.85 times D4 and D6 is from 0.15 times D4 to 0.7 times D4. More typically, D5 is from 0.3 times D4 to 0.8 times D4 and D6 is from 0.2 times D4 to 0.6 times D4. In most cases, D5 is from 0.4 times D4 to 0.7 times D4 and D6 is from 0.25 times D4 to 0.5 times D4.

When evaporation control cover 10 has a configuration similar to that of FIG. 5, i.e., evaporation control cover 10 is stationary with sample tray 2 moving beneath it, then D4 may be between about 0.5 mm and about 5.0 mm. More commonly, D4 may be between about 0.7 mm and about 4.5 mm. More typically, D4 will be between about 0.9 mm and about 3.9 mm. In this configuration, D5 may be from 0.2 times D4 to 0.85 times D4 and D6 is from 0.15 times D4 to 0.7 times D4. For example, when D4 is 2.0 mm, D5 may be between 0.4 mm and 1.7 mm and D6 may be between 0.3 mm and 1.4 mm. More typically, D5 is from 0.3 times D4 to 0.8 times D4 and D6 is from 0.2 times D4 to 0.6 times D4. In most cases, D5 is from 0.4 times D4 to 0.7 times D4 and D6 is from 0.25 times D4 to 0.5 times D4.

In some embodiments, the desired reduction in evaporation from sample wells 4 will be achieved when D5 is 50% of D4 and D6 is 33% of D4.

While the embodiments of evaporation control cover 10 described above provide enhanced fluid retention and consistency across each well 4, an alternative embodiment in which each hole 22 has identical diameters and each projecting port 42 has identical diameters will also provide enhanced fluid retention. See Table 2 below.

To provide for passage of sensor probe 12 through evaporation control cover 10, wettable insert 30 has a plurality of holes 32. Thus, holes 32 are also arranged in the same manner as holes 22 and upwardly projecting ports 42 such that upwardly projecting ports 42 pass through holes 32. Thus, the diameters of holes 32 correspond to the outside diameters of the corresponding upwardly projecting ports 42.

Tests were conducted to demonstrate the effectiveness of evaporation control cover 10. Each test was conducted over a 16-hour period at 25° C. using a shaker operating at 1000 RPM. For the tests conducted using evaporation control cover 10, wettable insert 30 is a polypropylene material with a thickness of 1.6 mm. The wetting liquid was deionized water.

Table 1 serves as a control and reflects the fluid loss from wells 4 in the absence of evaporation control cover 10. As reflected by Table 1, on average each well retained only 41.5% of the original fluid volume. The standard deviation for Table 1 is 3.2% and the coefficient of variation (% CV) is 7.6%. Table 2 reflects the improvement provided by use of evaporation control cover 10 with all holes 22 having a diameter of 3.4 mm. As reflected by Table 2, on average each well retained 93.2% of the original fluid volume. The standard deviation for Table 1 is 3.1% and the coefficient of variation (% CV) is 3.4%. Table 3 reflects the further improvement provided by using evaporation control cover 10 with varying diameter holes 22 as described above. In this instance, the outer perimeter holes (the holes within first outer perimeter row 52, second outer perimeter row 54, third outer perimeter row 56, and fourth outer perimeter row 58) have diameters of 2.4 mm, while holes 22 to the interior have diameters of 3.4 mm and holes 22 at locations 62, 64, 66, 68 have diameters of 2 mm. As reflected by Table 3, on average each well retained 93% of the original fluid volume. The standard deviation for Table 1 is 1.8% and the coefficient of variation (% CV) is 2.0%. For the sake of clarity and with reference to FIG. 1 and Tables 1-3, A1 corresponds to hole 22 at location 68, A12 corresponds to hole 22 at location 62, H1 corresponds to hole 22 at location 66 and H12 corresponds to hole 22 at location 64. The remaining positions in each Table correspond to holes 22 in a like manner.

Thus, use of evaporation control cover 10 more than doubled the amount of fluid retained in each well 4. While the fluid retention provided by evaporation control cover 10 with identical holes 22 and with holes 22 of differing diameters is essentially identical, the version with holes 22 of differing diameters provides the further improvement of enhanced consistency from one well 4 to another well 4. Clearly, evaporation control cover 10 will provide a significant improvement to the evaluation of analytes as the improved fluid retention will improve confidence in the analytic results.

TABLE 1
Control without Cover
% Liquid Remaining

| | 1 | 2 | 3 | 4 | 5 | 6 | 7 | 8 | 9 | 10 | 11 | 12 |
|---|---|---|---|---|---|---|---|---|---|---|---|---|
| A | 40.8 | 42.6 | 43.0 | 42.6 | 41.6 | 40.6 | 40.5 | 39.6 | 39.5 | 39.3 | 38.0 | 39.0 |
| B | 42.8 | 44.5 | 43.4 | 42.5 | 41.5 | 41.4 | 40.0 | 39.8 | 39.2 | 38.6 | 36.8 | 38.6 |
| C | 43.6 | 45.1 | 44.0 | 43.2 | 41.8 | 41.1 | 39.9 | 40.1 | 39.5 | 39.1 | 37.3 | 37.5 |
| D | 43.9 | 38.7 | 44.2 | 44.0 | 42.6 | 41.7 | 40.3 | 39.4 | 38.4 | 38.5 | 36.8 | 37.6 |
| E | 43.9 | 45.9 | 50.0 | 44.5 | 42.8 | 41.4 | 41.4 | 39.3 | 38.2 | 39.0 | 36.3 | 38.2 |
| F | 43.8 | 47.5 | 46.3 | 45.4 | 45.0 | 44.8 | 43.0 | 40.8 | 39.8 | 38.3 | 37.0 | 37.2 |
| G | 45.2 | 46.7 | 47.0 | 46.4 | 48.5 | 45.0 | 43.4 | 42.1 | 41.1 | 39.3 | 37.3 | 37.3 |
| H | 43.4 | 45.8 | 47.0 | 44.6 | 44.2 | 44.1 | 41.6 | 41.9 | 40.2 | 37.7 | 35.6 | 35.2 |

TABLE 2
With Cover
% Liquid Remaining

| | 1 | 2 | 3 | 4 | 5 | 6 | 7 | 8 | 9 | 10 | 11 | 12 |
|---|---|---|---|---|---|---|---|---|---|---|---|---|
| A | 81.3 | 88.9 | 89.7 | 90.0 | 90.8 | 90.2 | 91.3 | 91.3 | 90.9 | 90.9 | 88.8 | 88.2 |
| B | 93.6 | 94.3 | 95.0 | 95.8 | 95.2 | 96.0 | 95.3 | 94.7 | 95.5 | 95.4 | 95.0 | 90.0 |
| C | 93.0 | 95.4 | 95.5 | 96.0 | 96.0 | 95.8 | 87.3 | 95.4 | 96.2 | 95.4 | 95.6 | 89.4 |
| D | 93.6 | 95.5 | 95.5 | 94.5 | 95.7 | 94.9 | 94.3 | 96.4 | 96.2 | 95.6 | 95.4 | 89.2 |
| E | 93.6 | 95.2 | 96.1 | 95.5 | 96.4 | 94.7 | 95.9 | 95.4 | 96.5 | 95.3 | 95.0 | 87.7 |
| F | 91.6 | 96.8 | 95.5 | 95.6 | 95.5 | 95.8 | 95.3 | 94.8 | 95.1 | 95.8 | 93.1 | 87.3 |
| G | 90.7 | 94.3 | 94.9 | 94.9 | 94.7 | 95.9 | 95.7 | 94.9 | 94.8 | 93.8 | 93.6 | 88.9 |
| H | 86.6 | 91.3 | 90.4 | 90.9 | 88.6 | 93.8 | 91.7 | 91.0 | 90.8 | 91.2 | 85.1 | 85.5 |

TABLE 3
With Cover having Varying Diameter Holes
% Liquid Remaining

| | 1 | 2 | 3 | 4 | 5 | 6 | 7 | 8 | 9 | 10 | 11 | 12 |
|---|---|---|---|---|---|---|---|---|---|---|---|---|
| A | 93.0 | 93.4 | 92.6 | 91.9 | 91.2 | 91.0 | 90.7 | 88.7 | 87.8 | 86.3 | 87.4 | 87.3 |
| B | 93.1 | 93.1 | 94.6 | 93.5 | 96.9 | 93.7 | 95.8 | 92.5 | 92.4 | 92.3 | 98.0 | 89.7 |
| C | 91.7 | 95.0 | 92.0 | 94.2 | 93.8 | 94.3 | 93.8 | 94.0 | 93.0 | 92.5 | 90.2 | 90.6 |
| D | 91.3 | 94.1 | 93.9 | 94.0 | 94.3 | 92.8 | 93.8 | 93.4 | 93.3 | 92.9 | 94.1 | 91.0 |
| E | 90.7 | 94.9 | 94.3 | 94.9 | 94.1 | 93.9 | 94.0 | 93.2 | 92.5 | 93.0 | 94.0 | 92.8 |
| F | 92.3 | 93.7 | 94.0 | 93.3 | 93.5 | 93.5 | 93.3 | 92.8 | 92.6 | 92.9 | 92.2 | 93.5 |
| G | 91.9 | 93.9 | 94.3 | 93.4 | 93.8 | 93.7 | 94.3 | 93.6 | 93.0 | 93.4 | 93.6 | 93.5 |
| H | 90.7 | 92.4 | 94.0 | 93.9 | 93.7 | 94.7 | 94.8 | 94.6 | 94.2 | 94.0 | 93.9 | 93.8 |

In still another embodiment, evaporation control cover 10 has a configuration similar to that of FIG. 5, i.e., evaporation control cover 10 is stationary with sample tray 2 moving beneath it. However, in the alternative embodiment depicted in FIG. 7, evaporation control cover 10 is only top 20 as this configuration lacks a bottom. In the absence of a bottom, a wettable insert is also omitted from the cover 10. The embodiment of FIG. 7 includes the same arrangement of holes 22 discussed above and shown in FIG. 8. Specifically, holes 22 located to the interior of perimeter rows 52-58 have a first diameter (D1). Holes 22 within perimeter rows 52-58 have a second diameter (D2) which is less than the first diameter and corner holes 62, 64, 66 and 68 have a third diameter (D3). The third diameter is equal to or less than the second diameter. Thus, the diameters for each location can be stated as D1≥D2≥D3. The sizes of the first diameter, second diameter and third diameter will depend on the configuration of evaporation control cover 10. In this embodiment, D1 may be 0.5 mm and about 5.0 mm. More commonly, D1 may be between about 0.7 mm and about 4.5 mm. More typically, D1 will be between about 0.9 mm and about 3.9 mm. In this configuration, D2 may be from 0.2 times D1 to 0.85 times D1 and D3 is from 0.15 times D1 to 0.7 times D1. For example, when D1 is 2.0 mm, D2 may be between 0.4 mm and 1.7 mm and D3 may be between 0.3 mm and 1.4 mm. More typically, D2 is from 0.3 times D1 to 0.8 times D1 and D3 is from 0.2 times D1 to 0.6 times D1. In most cases, D2 is from 0.4 times D1 to 0.7 times D1 and D3 is from 0.25 times D1 to 0.5 times D1.

In some embodiments, an evaporation control cover described herein comprises a porous, wettable, free-standing material. It is also possible for an evaporation control cover to consist essentially of such a material and/or to consist of such a material. The porous, wettable, free-standing materials described herein may have a variety of suitable designs. In some embodiments, the porous, wettable, free-standing material has one of the designs described elsewhere herein for the evaporation control cover as a whole and/or one of the designs shown in FIGS. 1-9 for the evaporation control cover as a whole. In other words, in some embodiments, an evaporation control cover having a design described elsewhere herein consists essentially of and/or consists of a porous, wettable, free-standing material. Further exemplary designs for porous, wettable, free-standing materials and evaporation control covers are provided below.

The porous, wettable-free standing materials described herein may have sufficient mechanical strength to be free-standing. For instance, some free-standing materials do not depend on any other component in order to maintain their shape and/or their structural integrity. As another example, a free-standing material may, if positioned on a solid surface or a component with which it is designed to mate, not undergo appreciable deformation or flow absent the application of a force thereto. In some embodiments, a porous, wettable, free-standing material is free-standing when liquid-free, dry, and/or when wet by a liquid below a particular amount. Such materials, if wet in excess of that particular amount, may soften and become no longer free-standing. It is also possible for a porous, wettable, free-standing material to be free-standing when wet to a particularly high degree (e.g., some porous, wettable, free-standing materials may remain free-standing upon saturation with a liquid, such as upon saturation with water).

In some embodiments, the structural integrity of an evaporation control cover is provided by a porous, wettable, free-standing material therein. Such evaporation control covers may further comprise one or more other components that do not contribute to the structural integrity of the evaporation control cover and/or do not contribute substantially to the structural integrity of the evaporation control cover. For instance, such an evaporation control cover may further comprise one or more coatings and/or hydrophobic barriers disposed on the porous, wettable, free-standing material that do not so contribute and/or do not appreciably so contribute. In some embodiments, an evaporation control cover comprises a component that relies on the porous, wettable, free-standing material for structural integrity (e.g., a coating disposed on the porous, wettable, free-standing material, a tab or other structure disposed on the porous, wettable, free-standing material).

In some embodiments, a porous, wettable, free-standing material comprises one or more components that increase its structural integrity and/or stiffness. As two examples, in some embodiments, a porous, wettable, free-standing material comprises one or more glass fibers and/or one or more carbon fibers enhance its structural integrity and/or stiffness.

As used herein, when a component of an evaporation control cover is referred to as being “disposed on” another such component, it can be directly disposed on the other component, or an intervening component also may be present. A component that is “directly disposed on” another component means that no intervening component is present.

It is also possible for an evaporation control cover to comprise a porous, wettable, free-standing material that has sufficient mechanical strength to be free-standing and to further comprise one or more additional components that further contribute to the mechanical strength of the evaporation control cover. As one example, an evaporation control cover may comprise such a porous, wettable, free-standing material and further comprise a coating and/or a hydrophobic barrier that further enhances the mechanical strength of the evaporation control cover. The mechanical strength may be particularly enhanced when the porous, wettable, free-standing material is exposed to a fluid that wets it and/or is wet by such a fluid.

As noted above, the porous, wettable, free-standing materials described herein may be wettable. In other words, they may, when exposed to a fluid, absorb some or all of the fluid to which they are exposed. The absorption may comprise absorption into pores within the material but not into an interior of one or more solid components forming the material, absorption into an interior of one or more solid components forming the material but not into any pores in the material, and/or absorption into both pores within the material and an interior of one or more solid components forming the material. As one example of absorption into one or more solid components forming the material, the absorption may comprise dissolution of the fluid into a solid material present in a porous, wettable, free-standing material.

Some porous, wettable, free-standing materials are wettable by water. Some porous, wettable, free-standing materials may be wettable by liquid water. Some may be wettable by water vapor. It is also possible for a porous, wettable, free-standing material to be wettable by liquid water but not water vapor (or vice versa), or to be wettable by both liquid water and water vapor. Some porous, wettable, free-standing materials described herein may be configured to be wet by water and/or capable of being wet by water such that a relatively high percentage of the volume of the porous, wettable, free-standing material (i.e., inclusive of the pores therein), such as substantially all of its volume or almost all of its volume, is occupied by water.

In some embodiments, a porous, wettable, free-standing material is configured to release a fluid, capable of releasing a fluid, and/or releases a fluid. As one example, in some embodiments, if the porous, wettable, free-standing material is positioned in an environment that comprises the fluid at a relatively low level, such as a level that is in equilibrium with a lower concentration of the fluid in the porous, wettable, free-standing material, the porous, wettable, free-standing material may release the fluid (e.g., as a gas). This may be particularly beneficial when the fluid is water and the porous, wettable, free-standing material is employed in a low-humidity environment. In such embodiments, the porous, wettable, free-standing material may release water vapor, which may raise the humidity in the vicinity of the porous, wettable, free-standing material. This increase in humidity may suppress the evaporation of water from aqueous samples positioned close to the evaporation control cover, such as from sample wells in a multi-well sample tray on which the evaporation control cover is disposed.

Without wishing to be bound by any particular theory, porous, wettable, free-standing materials may be advantageous for use in evaporation control covers because they may be able to serve to increase the local concentration of a fluid with which they are wet in the vicinity of a multi-well sample tray over which they are positioned without requiring the presence of further components to provide structural integrity or to serve as a reservoir that can release fluid into the air. Evaporation control covers that require separate components to provide mechanical integrity and be wettable may undesirably have increased thickness and/or require more complex manufacturing techniques. Some such evaporation control covers may also be incompatible with multi-well sample trays having wells that are particularly small and/or closely spaced, as they may not be able to be manufactured (or may not be able to be manufactured facilely) to have geometries in which the wettable component is provided sufficiently proximate to the wells and is sufficiently mechanically supported.

In some embodiments, a porous, wettable, free-standing material has a design that is particularly suited for serving as a cover to a multi-well sample tray comprising a plurality of sample wells. For instance, the porous, wettable, free-standing material may be sized and/or shaped to fit over and/or mate with such a multi-well sample tray. As another example, the porous, wettable, free-standing material may be sized and/or shaped to allow access to wells in a multi-well sample tray. For instance, the porous, wettable, free-standing material may comprise one or more sample holes that are arranged such that, when the evaporation control cover is in use, each sample well is both beneath and vertically accessible by a sample hole. A sample well that is vertically accessible by a sample hole may be positioned such that a straight line can be drawn that passes perpendicularly through the sample hole and into the sample well. In some embodiments, a sample hole may have a size, shape, and/or position that allows for one or more sample wells positioned therebeneath when the evaporation control cover is in use to be accessed by a probe (e.g., a sensor probe, a BLI probe, an optical probe), that allows for the introduction and/or removal of one or more species from the sample wells (e.g., via pipetting), and/or that allows for sample wells to be subjected to optical imaging techniques. As another example, the sample holes may have a diameter that is sufficiently large to allow a probe (e.g., a sensor probe, a BLI probe, an optical probe) and/or a pipette to pass therethrough without damaging the porous, wettable, free-standing material.

An evaporation control cover may be in use when it is positioned in an intended manner on a multi-well sample tray. For instance, an evaporation control cover may be in use when it is mated with the multi-well sample tray and/or disposed stably on the multi-well sample tray. In some embodiments, an evaporation control cover is in use when it is disposed on a multi-well sample tray and the multi-well sample tray is positioned in a machine and/or an instrument, such as a machine and/or an instrument that is performing a measurement on one or more samples therein, that is being employed to incubate the multi-well sample tray, and/or that is being employed to perform a reactions in a fluid contained in a well in the multi-well sample tray.

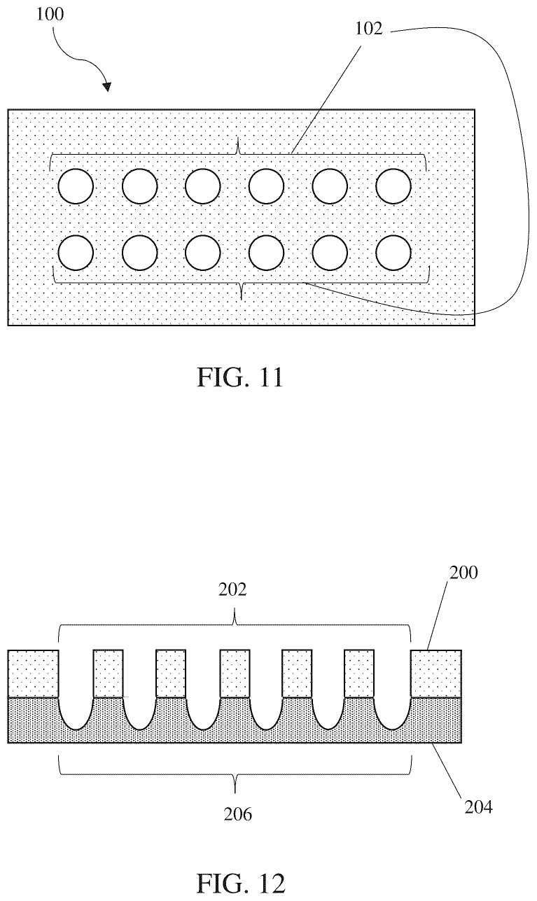

The sample holes present in a porous, wettable, free-standing material may have a variety of suitable designs. As one example, in some embodiments, a porous, wettable, free-standing material comprises a plurality of sample holes that are arranged to correspond to a plurality of sample wells in a multi-well sample tray. FIG. 11 shows one non-limiting example of a top view of an exemplary porous, wettable, free-standing material having this design, and FIG. 12 shows a side view of this material disposed on a multi-well sample tray. In FIG. 11, the porous, wettable, free-standing material 100 comprises a plurality of sample holes 102. In FIG. 11, the plurality of sample holes is arranged to form a grid, such as a grid that corresponds to a grid of sample wells in a multi-well sample tray. It should be understood that the relative size of the sample holes, their number, and their specific arrangement shown in FIG. 11 is exemplary and that other porous, wettable, free-standing materials may include sample holes having a different relative size, in a different number, and/or in a different arrangement.

FIG. 12 shows an exemplary porous, wettable, free-standing material 200 that is disposed on a multi-well sample tray 204. The porous, wettable, free-standing material 200 comprises a plurality of sample holes 202, and the multi-well sample tray 204 comprises a plurality of sample wells 206. As can be seen from FIG. 12, in some embodiments, a porous, wettable, free-standing material has a design such that the sample holes are arranged to correspond to the sample wells in a multi-well sample tray. The sample holes shown in FIG. 12 are positioned above the sample wells and are positioned such that, for each sample hole and sample well, a line can be drawn that passes through the sample hole and into the sample well and that line is perpendicular to the sample hole.

As shown in FIGS. 11 and 12, in some embodiments, a porous, wettable, free-standing material comprises at least one sample hole that, when the evaporation control cover is in use, exactly one sample well is therebeneath and vertically accessible thereby. As shown in these Figures, it is possible for all sample holes present in a porous, wettable, free-standing material to have this property. It is also possible for a porous, wettable, free-standing material to comprise at least one sample hole that, when the evaporation control cover is in use, two or more sample wells are beneath and are vertically accessible thereby. Some porous, wettable, free-standing materials may exclusively comprise sample holes of the former type, exclusively comprise sample holes of the latter type, or comprise sample holes of both types. In some embodiments, a porous, wettable, free-standing material includes exactly one sample hole that all the sample wells are beneath and vertically accessible thereby.

Some porous, wettable, free-standing materials have an arrangement of sample holes such that, when the evaporation control cover is in use with a multi-well sample tray, each sample well in the multi-well sample tray is positioned beneath and is vertically accessible by a sample hole. It is also possible for a porous, wettable, free-standing material to have an arrangement of sample holes such that, when the evaporation control cover is in use with a multi-well sample tray, at least one sample well in the multi-well sample tray is not positioned beneath a sample hole and/or is not vertically accessible by a sample hole.

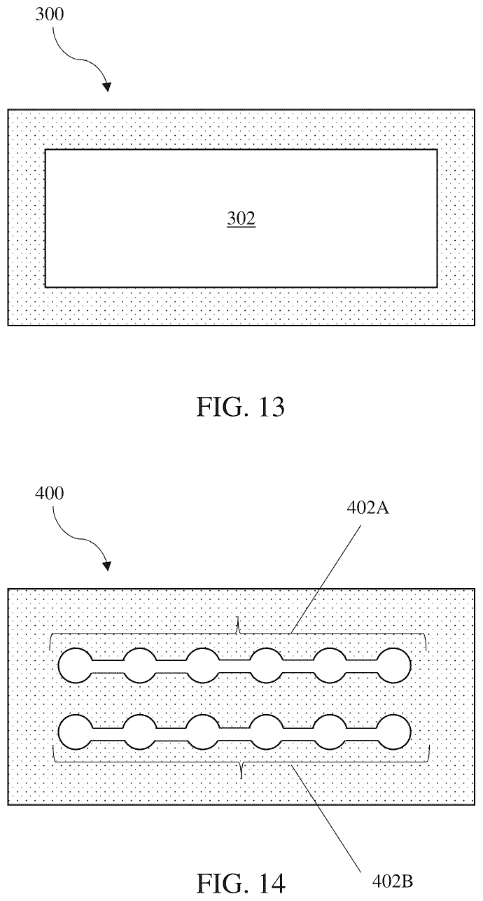

FIGS. 13-15 show further exemplary designs for porous, wettable, free-standing materials.

In FIG. 13, the porous, wettable, free-standing material 300 includes a single sample hole 302. When in use, this sample hole would be positioned such that all of the sample wells in the multi-well sample tray with which it is in use would be therebeneath and vertically accessible thereby.

In FIG. 14, the porous, wettable, free-standing material 400 includes two sample holes: 402A and 402B. When this porous, wettable, free-standing material is in use, there would be six sample wells positioned beneath and vertically accessible by each sample hole. As can also be seen in FIG. 14, in some embodiments, a sample hole may have a geometry comprising one or more portions that correspond to a plurality of sample wells (e.g., one or more circular portions) that are connected by other portions (e.g., that are connected by slits).

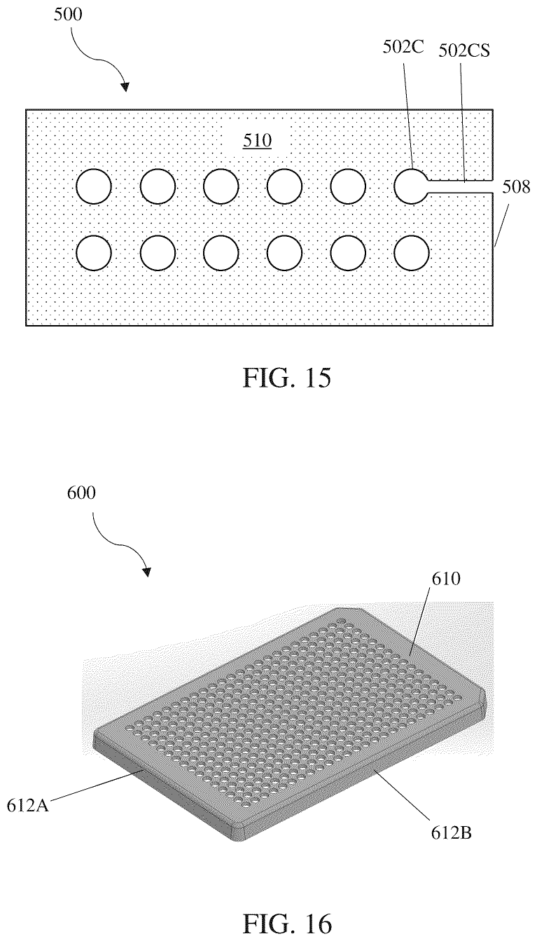

FIG. 15 depicts a porous, wettable, free-standing material 500. As can be seen from FIG. 15, the sample hole 502C comprises a slit 502CS that extends to the edge 508 of the central body portion 510. Although FIG. 15 shows only one sample hole that comprises a slit, it should be understood that it is possible for a porous, wettable, free-standing material to comprise more than one sample hole that comprises a slit and/or for a porous, wettable, free-standing material to comprise holes having a different geometry than that shown in FIG. 15 but still comprise one or more sample holes comprising a slit.

In addition to sample holes, the evaporation control covers described herein may comprise one or more further structural features. Such structural features may facilitate the use of the evaporation control cover with a multi-well sample tray. For example, in some embodiments, an evaporation control cover is shaped such that it corresponds to the shape of a multi-well tray. As one example, a multi-well sample tray may have a shape that comprises one or more features (e.g., beveled corners) and the evaporation control cover may have a shape that comprises these same features. As another example, a multi-well sample tray may comprise one or more notches, and an evaporation control cover may comprise one or more components that can fit around, mechanically couple to, and/or mate with such notch(es). In some embodiments, an evaporation control cover has a shape such that it can only fit onto a multi-well sample tray, be mechanically coupled to a multi-well sample tray, and/or mate with a multi-well sample tray in a single configuration. For instance, a multi-well sample tray may have a shape that lacks rotational symmetry, and the evaporation control cover may have this same shape.

Further Figures depicting exemplary designs for evaporation control covers are described in the following text. It should be understood that some evaporation control covers may have one or more features of the designs shown in one or more of these Figures but have an arrangement of sample holes that is different from the arrangement of the sample holes in these Figures. For instance, an evaporation control cover may have one or more such features but have an arrangement of sample holes corresponding to that shown in one of FIGS. 13-15.

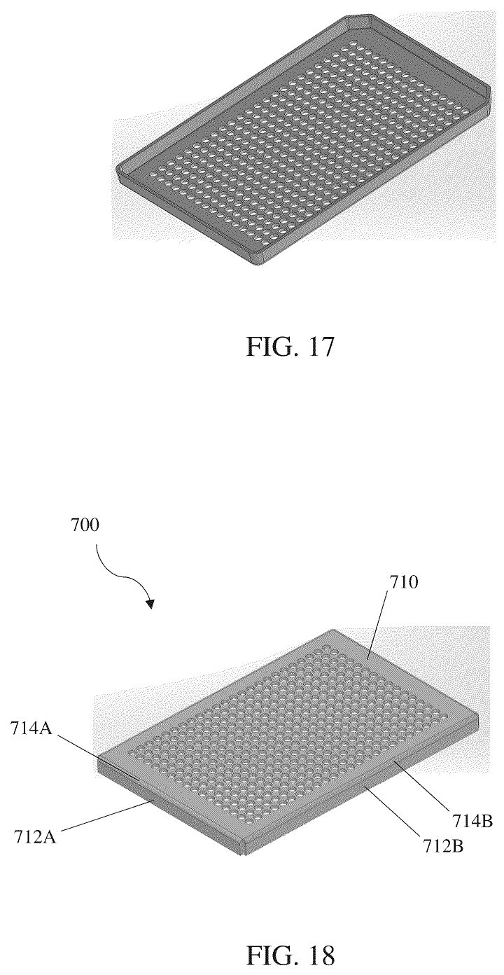

In some embodiments, an evaporation control cover, and/or a porous, wettable, free-standing material therein, comprises one or more flanges. In such embodiments, the evaporation control cover, and the porous, wettable, free-standing material therein, may comprise a central body portion comprising a plurality of sample holes and may further comprise the one or more flanges. FIG. 16 shows one non-limiting example of a porous, wettable, free-standing material 600 comprising the central body portion 610 and the flanges 612A and 612B. FIG. 17 shows a view of the underside of this porous, wettable, free-standing material.

The flange(s) described herein may be connected to a central body portion of an evaporation control cover (e.g., integrally) and/or may extend at an angle from the central body portion. In some embodiments, a flange is separated from a central body portion by a fold. For instance, the evaporation control cover may comprise a porous, wettable, free-standing material that extends across a central body portion and one or more flanges. The porous, wettable, free-standing material may be folded such that one or more of the flanges (and/or each flange) is separated from the central body portion by a fold. In such embodiments, some or all of the flange(s) may be positioned on opposing sides of fold(s) in the porous, wettable, free-standing material from the central body portion. FIG. 18 shows one non-limiting embodiment of a porous, wettable, free-standing material 700 that comprises a central body portion 710 and the flanges 712A and 712B. The flanges 712A and 712B are separated from the central body portion 710 by the folds 714A and 714B, respectively.

In some embodiments, an evaporation control cover and/or a porous, wettable, free-standing material comprises a plurality of flanges that are folded such that they interlock to form a structure that maintains a three-dimensional geometry of the evaporation control cover and/or porous, wettable, free-standing material. For instance, the flanges may be folded such that they interlock so that they are stably maintained at an angle other than 0° with respect to a central body portion (e.g., so that they are stably maintained at an angle of approximately 90° with respect to a central body portion).

It is also possible for an evaporation control cover described herein to comprise flanges that are attached to a central body portion at a location other than a fold. As one example, in some embodiments, an evaporation control cover is formed from a porous, wettable, free-standing material that is molded such that it comprises both a central body portion and one or more flanges. FIGS. 16 and 17, among others, show evaporation control covers having this design. As can be seen in FIGS. 16 and 17, in some embodiments, an evaporation control cover comprises a flange that is connected to a central body portion via a bevel.

As another example of a manner in which a flange may be connected to a central body portion, an evaporation control cover may comprise one or more flanges that are adhered to a central body portion (e.g., via an adhesive).

When present, the flange(s) may assist with positioning evaporation control covers and/or porous, wettable, free-standing material over a multi-well sample tray. For instance, the flange(s) may have a length and geometry such that, when positioned to stand on the flanges, the evaporation control cover is positioned such that the central body portion is disposed above the multi-well sample tray. Such flanges may allow for the evaporation control cover and/or the porous, wettable, free-standing material to cover the multi-well sample tray while not being mechanically couped thereto. As another example, the flange(s) may have a shape that fits around a multi-well sample tray. This may take the form of flanges that enclose a shape that is geometrically similar to, but larger than, the shape of a multi-well sample tray and/or that allows for only de minimis movement of a multi-well sample tray enclosed in the flanges (e.g., movement that does not allow the multi-well sample tray to change its orientation with respect to the flanges).

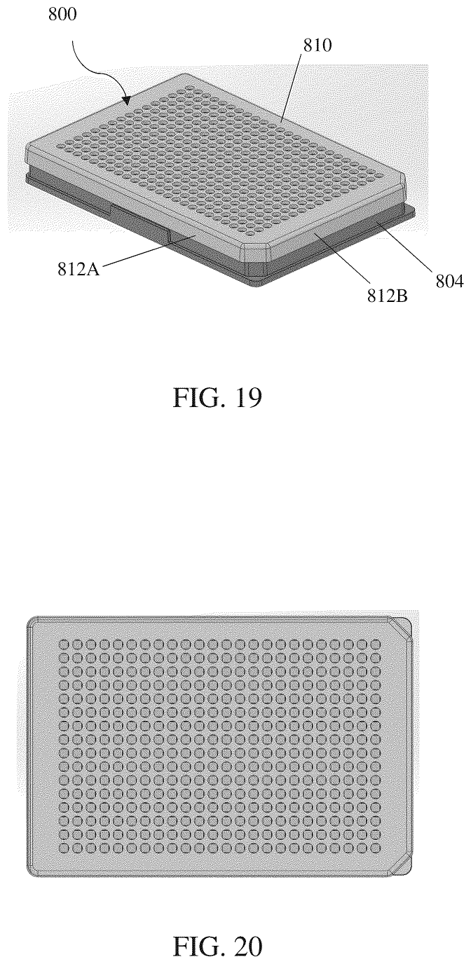

In some embodiments, an evaporation control cover and/or a porous, wettable, free-standing material therein comprises one or more flanges that mechanically couple the evaporation control cover to a multi-well sample tray. As an example, an evaporation control cover and/or a porous, wettable, free-standing material therein may comprise one or more flanges that have a shape that mates with a multi-well sample tray. Such flanges may secure the evaporation control cover to the multi-well sample tray (e.g., at a particular orientation). The mating may comprise the physical interlocking of one or more portions of the flange(s) with one or more portions of the multi-well sample tray (e.g., involving compression or not). FIG. 19 shows one non-limiting example of a porous, wettable, free-standing material 800 comprising a central body portion 810 and the flanges 812A and 812B that have shapes that mate with a microwell plate 804. FIG. 20 shows another view of these two components.

Some evaporation control covers and porous, wettable, free-standing materials therein comprise flange(s) that have a shape that retains the evaporation control cover on the multi-well sample tray during lateral shaking of the multi-well sample tray by a shaker and/or that maintains the position of the sample holes with respect to the sample wells during lateral shaking of the multi-well sample tray by a shaker. This may be accomplished by mating between the flange(s) and the multi-well sample tray that is relatively strong and/or that is not dislodged by the motion applied by the shaker. Without wishing to be bound by any particular theory, flanges that maintain such positioning of the evaporation control cover may be particularly desirable because they may allow for a probe to be positioned proximate to the sample wells while the multi-well sample tray is being shaken and while the evaporation control cover is disposed thereon. This may allow for the use of a probe to perform measurements under conditions in which both shaking is performed and the evaporation control cover is employed to reduce evaporation.

It should also be understood that the flange designs shown in the Figures, including FIGS. 16-20, are exemplary and that other flange designs are also possible.

It is also possible for an evaporation control cover and/or a porous, wettable, free-standing material to comprise a component other than a flange that mechanically couples the evaporation control cover to a multi-well sample tray, retains the evaporation control cover on the multi-well sample tray during lateral shaking of the multi-well sample tray by a shaker, and/or that maintains the position of the sample holes with respect to the sample wells during lateral shaking of the multi-well sample tray by a shaker. As one example, an evaporation control cover and/or a porous, wettable, free-standing material may comprise a tab, such as a tab that has a shape that mates with a multi-well sample tray. The tab may extend downwards from and/or inwards to the evaporation control cover and/or the porous, wettable, free-standing material (and/or a central body portion thereof). Some tabs may, additionally or alternatively, be positioned at a location and in a direction such that they can mate with the multi-well sample tray. The mating may comprise the physical interlocking of one or more portions of the tab with one or more portions of the multi-well sample tray (e.g., involving compression or not). In some embodiments, a tab may have a shape that mates with an inner perimeter of a multi-well sample tray, a well present in a multi-well sample tray, and/or a rib present in a multi-well sample tray.

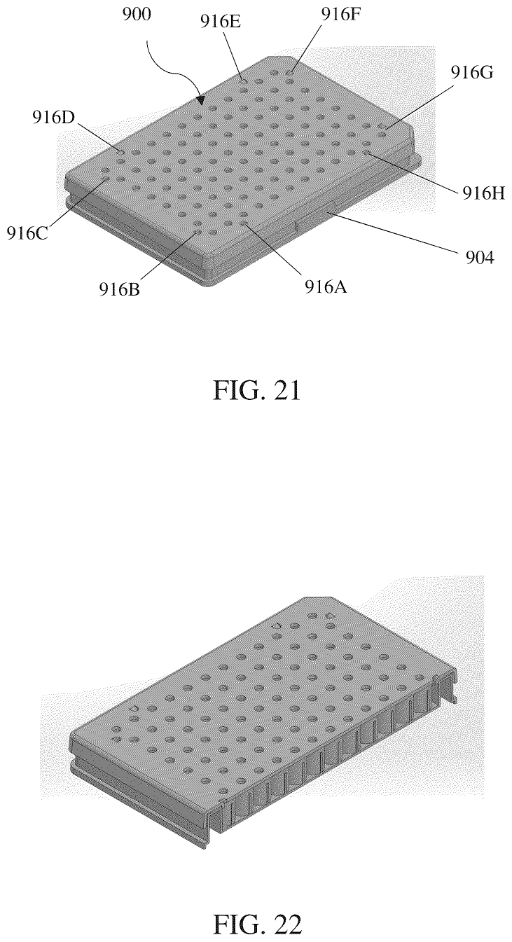

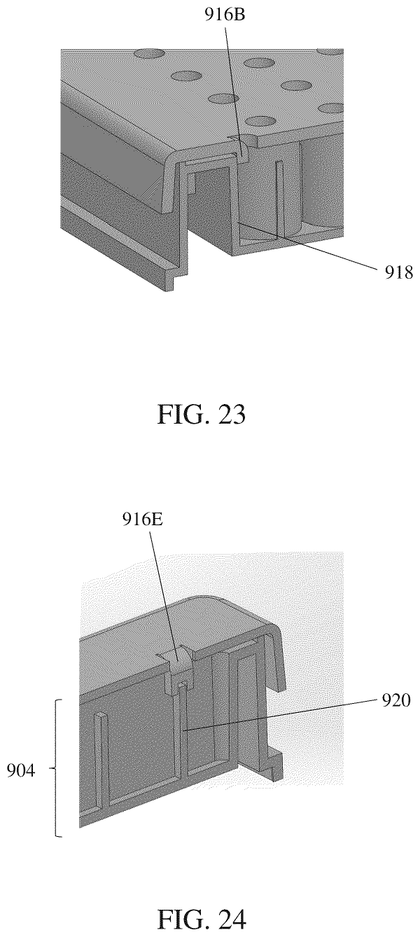

FIG. 21 shows an example of a porous, wettable, free-standing material 900 comprising the tabs 916A-H that have a shape that mates with the inner perimeter and ribs of a multi-well sample tray 904. FIGS. 22-24 show further views of this porous, wettable, free-standing material and sample tray. FIG. 23 shows mating between the tab 916B and the inner perimeter 918, and FIG. 24 shows mating between the tab 916E and the rib 920 present in the multi-well sample tray 904.

In some embodiments, an evaporation control cover and/or a porous, wettable, free-standing material comprises more than one tab (e.g., a plurality of tabs).

It should also be understood that the tab designs shown in the Figures, including FIGS. 21-24, are exemplary and that other tab designs are also possible.

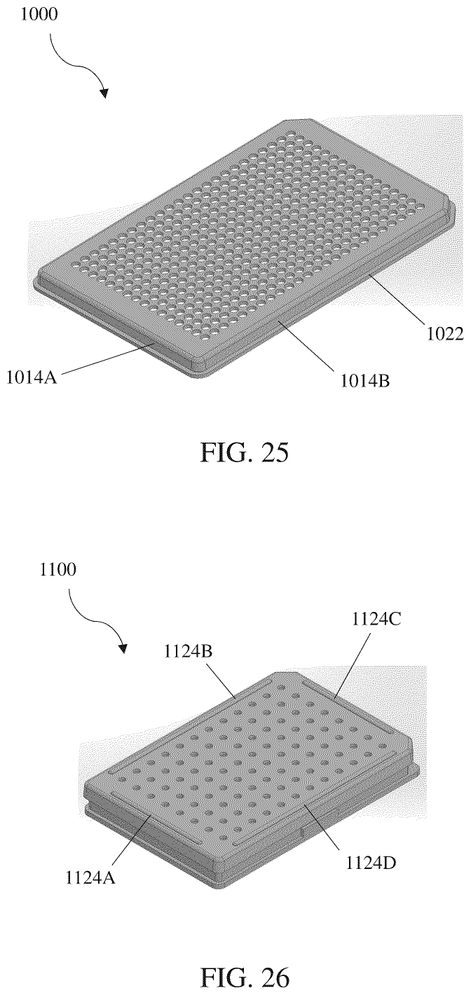

As another example, in some embodiments, an evaporation control cover and/or a porous, wettable, free-standing material comprises a lip. When present, the lip may retain the evaporation control cover on the multi-well sample tray during lateral shaking of the multi-well sample tray by a shaker, maintain the position of the sample holes with respect to the sample wells during lateral shaking of the multi-well sample tray by a shaker, enhance the stiffness of the evaporation control cover and/or the porous, wettable, free-standing material, and/or simplify manufacturing (e.g., by allowing for cutting to be employed). The lip may extend outwards from one or more flanges to provide further positional stability to the evaporation control cover and/or the porous, wettable, free-standing material. In some embodiments, the lip extends parallel to a surface on which the evaporation control cover and/or the porous, wettable, free-standing material is positioned and/or extends parallel to a central body portion of an evaporation control cover and/or a porous, wettable, free-standing material. FIG. 25 shows one non-limiting example of a porous, wettable, free-standing material 1000 comprising the flanges 1014A and 1014B and further comprising a lip 1022.

It should also be understood that the lip designs shown in the Figures, including FIG. 25, are exemplary and that other lip designs are also possible.

As third and fourth examples, in some embodiments, an evaporation control cover and/or a porous, wettable, free-standing material comprises one or more ribs and/or one or more embossments that retain the evaporation control cover on the multi-well sample tray during lateral shaking of the multi-well sample tray by a shaker and/or that maintains the position of the sample holes with respect to the sample wells during lateral shaking of the multi-well sample tray by a shaker. Further details regarding exemplary designs for ribs and embossments are provided below. Without wishing to be bound by any particular theory, it is believed that ribs and embossments may also, additionally or alternatively, desirably enhance the stiffness of porous, wettable, free-standing materials in which they are positioned. It is believed that ribs and embossments may increase the second moment of area of the porous, wettable, free-standing material, which may result in such increased stiffness.

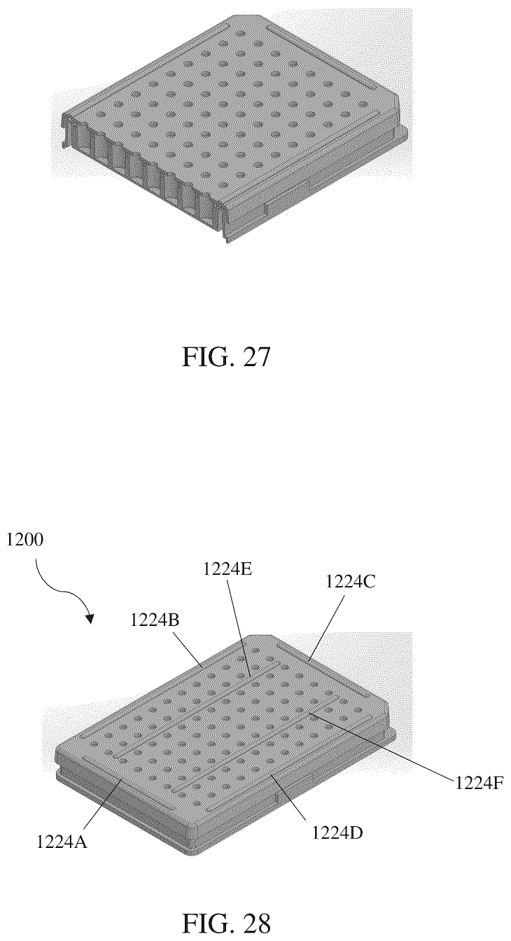

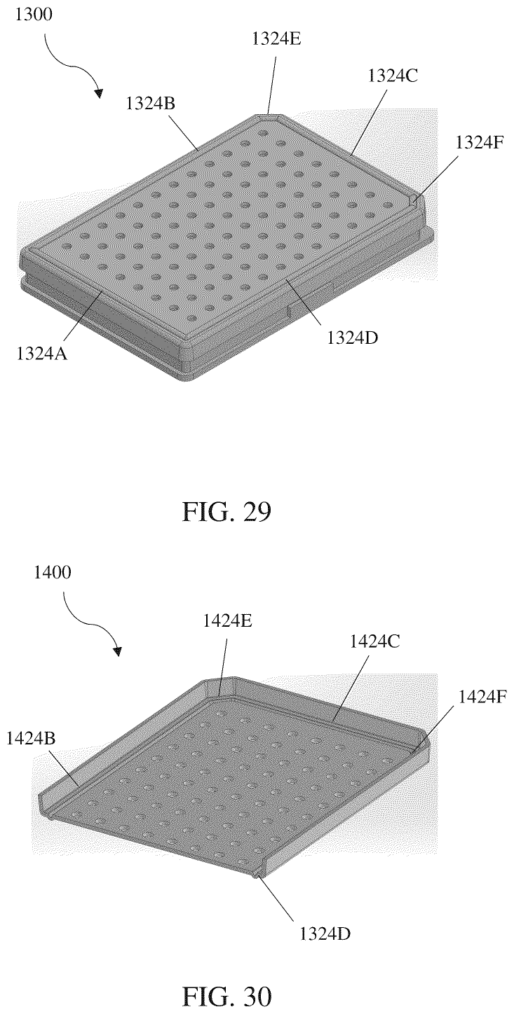

In some embodiments, an evaporation control cover and/or a porous, wettable, free-standing material comprises one or more ribs (e.g., a plurality of ribs). The rib(s) may project upwards from the rest of the evaporation control cover. For instance, in some embodiments, one or more ribs may be disposed on a central body portion and may project upwards from the central body portion. FIGS. 26-30 depict evaporation control covers that include ribs having various designs. FIGS. 26, 28, and 29 depict evaporation control covers disposed on multi-well sample trays. FIG. 27 shows a sectioned view of the evaporation control cover shown in FIG. 26, and FIG. 30 shows a sectioned view of the underside of the evaporation control cover shown in FIG. 29.

As can be seen from FIGS. 26-30, a variety of rib designs may be employed. With respect to FIG. 26, the porous, wettable, free-standing material 1000 comprises the ribs 1024A-D. As shown in FIG. 27, an evaporation control cover and/or a porous, wettable, free-standing material may comprise one or more ribs that are parallel to the edges of the evaporation control cover and/or the porous, wettable, free-standing material. As can also be seen from this Figure, an evaporation control cover and/or a porous, wettable, free-standing material may comprise one or more ribs that are external to sample holes also present in the evaporation control cover and/or the porous, wettable, free-standing material. Additionally, an evaporation control cover and/or a porous, wettable, free-standing material may comprise ribs that do not intersect. Similarly, an evaporation control cover and/or a porous, wettable, free-standing material may comprise one or more ribs that are straight.

As shown in FIG. 28, it is also possible for an evaporation control cover and/or a porous, wettable, free-standing material to comprise one or more ribs that are positioned interior to some of the sample holes also present in the evaporation control cover and/or the porous, wettable, free-standing material. In FIG. 28, these are the ribs 1224E and 1224F, which are present along with the ribs 1224A-D in the porous, wettable, free-standing material 1200.

As shown in FIG. 29, it is also possible for an evaporation control cover and/or a porous, wettable, free-standing material to comprise one or more ribs that intersect. In FIG. 29, a porous, wettable, free-standing material 1300 comprises the ribs 1324A-1324F, which intersect each other at their termini. These ribs together form a polygonal ring that encloses the sample holes and that is proximate to the outer perimeter of the central body portion.

It should be understood that the evaporation control covers and porous, wettable, free-standing materials described herein may comprise ribs having morphologies other than those shown in FIGS. 26-30. For instance, in some embodiments, an evaporation control cover and/or a porous, wettable, free-standing material comprises one or more ribs that are curved or bent and/or one or more ribs that are positioned in other locations than those shown in FIGS. 26-30. It is also possible for an evaporation control cover and/or for a porous, wettable, free-standing material to comprise intermittent ribs, ribs that surround each hole, ribs that are positioned between each pair of holes, or ribs having yet other designs. Additionally, ribs may have dimensions and/or relative dimensions other than those shown in FIGS. 26-30.

Ribs may be formed from the same material as the portion of the evaporation control cover on which they are disposed (e.g., they may comprise a porous, wettable, free-standing material that is the same porous, wettable, free-standing material on which they are disposed) or they may be formed from a different material (e.g., a different porous, wettable, free-standing material, a different type of material). In some embodiments, an evaporation control cover comprises ribs that are integrally connected with the portion of the evaporation control cover on which they are disposed (e.g., without the use of adhesive), are formed during the same process as the portion of the evaporation control cover on which they are disposed (e.g., by deposition of a precursor to that portion of the evaporation control cover into a mold), and/or are formed by a process that modifies an existing portion of the evaporation control cover to form the rib (e.g., an embossing process).

The underside of a portion of an evaporation control cover on which a rib is disposed may include no topological features that indicate that a rib is disposed on the opposing side thereof or may comprise one or more such topological features. In some embodiments, an evaporation control cover and/or a porous, wettable, free-standing material comprises one or more ribs that extend through their thickness. Such ribs may include an indentation on the opposing side of the evaporation control cover and/or the porous, wettable, free-standing material. This indentation may have a shape that is a negative of the rib (i.e., it may have a shape in which the rib could fit exactly), may have a shape that is geometrically similar to a negative of the rib, and/or may have a shape that is correlated to a negative of the rib but that is shallower and/or narrower than the negative of the rib. FIG. 30 shows one non-limiting example of a porous, wettable, free-standing material 1400 that comprises the ribs 1424B-F that extend through the thickness of the porous, wettable, free-standing material.

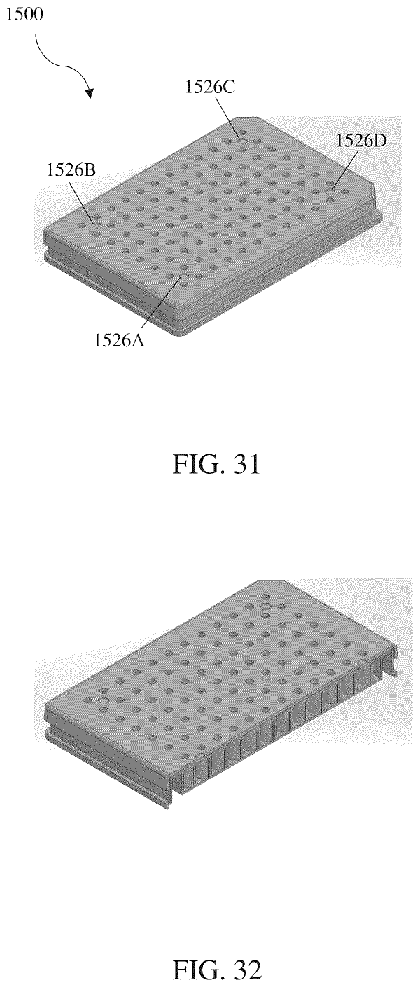

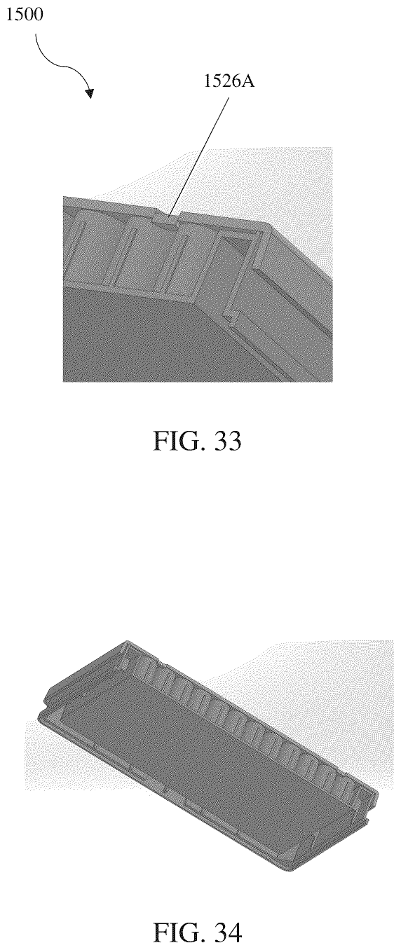

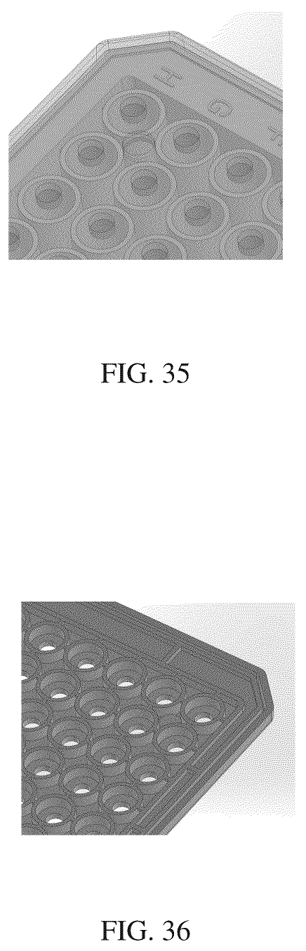

In some embodiments, an evaporation control cover and/or a porous, wettable, free-standing material comprises one or more embossments (e.g., a plurality of embossments). The embossment(s) may project downwards from the rest of the evaporation control cover. For instance, in some embodiments, one or more embossments may be disposed on a central body portion and may project downwards from the central body portion. FIGS. 31-36 show different views of an exemplary porous, wettable, free-standing material comprising embossments. These Figures further show the presence of multi-well sample trays on which the porous, wettable, free-standing material is disposed. FIG. 35 shows a view in which the porous, wettable, free-standing material is rendered transparently. FIGS. 34 and 36 show views of the underside of the porous, wettable, free-standing material. In FIG. 33, the multi-well sample tray is rendered such that the porous, wettable, free-standing material can be observed.

With respect to FIG. 31, the porous, wettable, free-standing material 1500 comprises the embossments 1526A-D. As can be seen from FIG. 31, the embossments may be positioned interior to some sample holes and/or external to some sample holes. Like in FIG. 31, the embossments may have a circular cross-section (e.g., parallel to a surface in the porous, wettable, free-standing material in which they are positioned). It is also possible for embossments to include cross-sections (e.g., parallel to a surface in the porous, wettable, free-standing material in which they are positioned) having other shapes, such as rectangular or obround. The shape may be analytical (e.g., it may be a shape that can be precisely defined by a mathematical function, such as a polygon and/or a shape that comprises one or more mathematically defined curves) or organic (e.g., it may be a shape that is irregular in one or more ways).

As can be seen from FIGS. 33, 35, and 36, in some embodiments, an evaporation control cover and/or a porous, wettable, free-standing material comprises embossments that are positioned such that, when the evaporation control cover is disposed on a sample tray, the embossments are positioned between sample wells. Such positioning may involve mating (e.g., via compression) between the embossments and the spaces between the sample wells.

Embossments may be formed from the same material as the portion of the evaporation control cover on which they are disposed (e.g., they may comprise a porous, wettable, free-standing material that is the same porous, wettable, free-standing material on which they are disposed) or they may be formed from a different material (e.g., a different porous, wettable, free-standing material, a different type of material). In some embodiments, an evaporation control cover comprises embossments that are integrally connected with the portion of the evaporation control cover on which they are disposed (e.g., without the use of adhesive), are formed during the same process as the portion of the evaporation control cover on which they are disposed (e.g., by deposition of a precursor to that portion of the evaporation control cover into a mold), and/or are formed by a process that modifies an existing portion of the evaporation control cover to form the embossment (e.g., an embossing process).

The opposing side of a portion of an evaporation control cover on which an embossment is disposed may include no topological features that indicate that an embossment is disposed on the opposing side thereof or may comprise one or more such topological features. In some embodiments, an evaporation control cover and/or a porous, wettable, free-standing material comprises one or more embossments that extend through their thickness. Such embossments may include an indentation on the opposing side of the evaporation control cover and/or the porous, wettable, free-standing material. This indentation may have a shape that is a negative of the embossment (i.e., it may have a shape in which the embossment could fit exactly), may have a shape that is geometrically similar to a negative of the embossment, and/or may have a shape that is correlated to a negative of the embossment but that is shallower and/or narrower than the negative of the rib. FIG. 33 shows one non-limiting example of a porous, wettable, free-standing material 1500 that comprises the embossment 1326A that extends through the thickness of the porous, wettable, free-standing material.

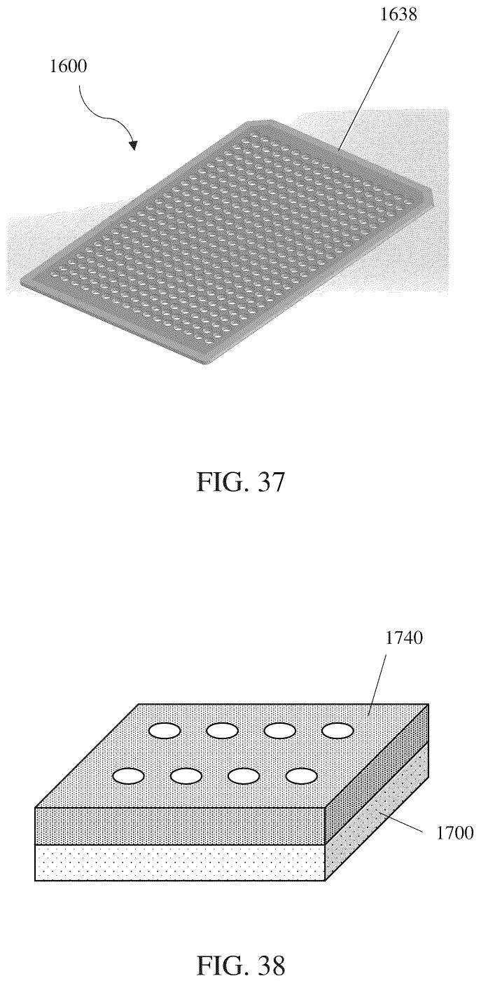

A final example of a component that mechanically couples the evaporation control cover to a multi-well sample tray, retains the evaporation control cover on the multi-well sample tray during lateral shaking of the multi-well sample tray by a shaker, and/or that maintains the position of the sample holes with respect to the sample wells during lateral shaking of the multi-well sample tray by a shaker is an adhesive. In some embodiments, an adhesive is disposed on a lower surface of an evaporation control cover and/or porous, wettable, free-standing material therein. For instance, an adhesive may be disposed on a lower surface of a central body portion. When present, the adhesive may adhere the evaporation control cover and/or the porous, wettable, free-standing material to a multi-well sample tray on which it is disposed. FIG. 37 depicts a lower surface of a porous, wettable, free-standing material 1600 on which an adhesive 1638 is disposed. As shown in FIG. 37, an adhesive may be positioned external to the sample holes present in the porous, wettable, free-standing material and/or may form a polygonal ring that encloses such sample holes. It is also possible for an adhesive to have a different geometry (e.g., it may not form a polygonal ring, it may comprise one or more discontinuous parts, and/or it may be positioned internal to one or more sample holes).

In some embodiments, an evaporation control cover comprises a coating. When present, the coating may be disposed on one or more surfaces of a porous, wettable, free-standing material therein (e.g., in the form of a coating). For instance, the coating may be disposed on an upper surface of a porous, wettable, free-standing material and/or on a lower surface of a porous, wettable-free standing material. The surface on which the coating is disposed may be a surface present in a central body portion. FIG. 38 depicts one non-limiting example of a porous, wettable, free-standing material 1700 on which a coating 1740 is disposed. As shown in FIG. 38, in some embodiments, a coating has a shape that matches the shape of the underlying or overlying porous, wettable, free-standing material. However, other designs are also possible. For instance, the coating may partially, but not fully, cover the underlying or overlying porous, wettable, free-standing material.

In some embodiments, a coating present in an evaporation control cover acts as a barrier to vapor transport through the evaporation control cover. For instance, the coating may repel the vapor, the vapor may have a low solubility in the coating, and/or the vapor may have a low diffusivity through the coating. In some embodiments, the coating is hydrophobic and/or acts as a barrier to water vapor transport through the evaporation control cover. Without wishing to be bound by any particular theory, the presence of such a barrier may assist with retaining fluid in the porous, wettable, free-standing material and/or proximate to a multi-well sample tray on which the evaporation control cover is disposed. For instance, the barrier may reduce or prevent the transport of vapor therethrough, which may prevent fluid from evaporating from a wetted porous, wettable, free-standing material and diffusing away therefrom. This may also reduce or prevent the diffusion of air comprising a vapor (e.g., humid air) enclosed by the porous, wettable, free-standing material (and proximate to a multi-well sample tray on which the porous, wettable, free-standing material is disposed) from diffusing away from the multi-well sample tray, thereby maintaining a relatively high local vapor concentration (e.g., local humidity) in the vicinity of the multi-well sample tray.

As noted above, coatings that are present on a porous, wettable, free-standing material may be disposed on upper and/or lower surfaces thereof. In some such embodiments, a porous, wettable, free-standing material may comprise one or more surfaces that are coated by a coating and may also comprise one or more surfaces on which the coating is not disposed. For instance, a porous, wettable, free-standing material may have side surfaces and/or surfaces laterally surrounding some or all of the sample holes (e.g., surfaces that laterally surround the sample holes and topologically connect the top and bottom opposing surfaces of the porous, wettable, free-standing material) that are uncoated. Uncoated surfaces laterally surrounding sample holes may facilitate the transport of vapor between the porous, wettable, free-standing material and an environment in contact therewith through such surfaces. In some embodiments, a porous, wettable, free-standing material comprises a bottom surface of a flange (e.g., the lowermost surface of the flange, such as the surface on which the flange stands) that is uncoated. It is believed that leaving one or more surfaces of a flange uncoated may desirably reduce dripping of any vapor condensed on the evaporation control cover.

A variety of suitable coatings may be employed in the evaporation control covers described herein. Non-limiting examples of suitable hydrophobic barriers include waxes, plastic laminates, and acrylic coatings. In some embodiments, an evaporation control cover comprises a coating that is laminated to a porous, wettable, free-standing material.

In evaporation control covers comprising coatings, manufacturing such evaporation control covers may comprise applying the coating at any suitable point in time. In some embodiments, an evaporation control cover is manufactured by forming a porous, wettable, free-standing material (e.g., from a pulp), applying a coating to the porous, wettable, free-standing material, and then forming sample holes in the coated porous, wettable, free-standing material (e.g., by cutting away or punching out the sample holes). Without wishing to be bound by any particular theory, it is believed that manufacturing an evaporation control cover in this manner may allow for the resultant evaporation control cover to comprise surfaces laterally surrounding the sample holes that are uncoated by the coating. In embodiments in which an evaporation control cover comprises a coating disposed on a porous, wettable, free-standing material and further comprises flanges that are formed by folding, the folding may occur after coating of the porous, wettable, free-standing material.

In some embodiments, a porous, wettable, free-standing material comprises a plurality of pores. As noted above, such pores may be capable of absorbing a fluid, configured to absorb a fluid, and/or may absorb a fluid (e.g., a fluid to which the porous, wettable, free-standing material is exposed, such as liquid water and/or water vapor). It is also possible for such pores to contain a liquid, such as a liquid that has been absorbed by the porous, free-standing material (e.g., water).

The pluralities of pores described herein may comprise pores having a variety of suitable morphologies. Such pores may comprise open pores and/or interconnected pores. In some embodiments, a porous, wettable, free-standing material comprises a plurality of pores that form a network that spans the material and/or one or more regions thereof. Such a network may have a pore density that is relatively uniform (e.g., that varies by less than or equal to 10%, 5%, 2%, or 1%) across the region spanned.

Some pluralities of pores comprise pores that take the form of gaps, interstices, and/or openings within the material in which they are positioned and/or between components positioned therein (e.g., for fibrous materials, some pores may take the form of spaces between fibers). In some embodiments, the pores within a plurality of pores are not uniformly sized, shaped, and/or positioned within the porous, wettable, free-standing material.

In some embodiments, a plurality of pores has a morphology that promotes the flow of liquid thereinto via capillarity. For instance, in some embodiments, the plurality of pores comprises open pores having a size that promotes such flow.

The pluralities of pores described herein may comprise pores having a variety of suitable sizes. In some embodiments, a plurality of pores comprises pores having a size of greater than or equal to 1micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, a plurality of pores comprises pores having a size of less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 15 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 100 microns). Other ranges are also possible.

In some embodiments, the pores in a plurality of pores fall within a size range that corresponds to one or more of the above-referenced ranges (e.g., all of the pores in a plurality of pores may have a size of between 1 micron and 100 microns). In some embodiments, the average size of the pores within a plurality of pores falls within one or more of the above-referenced ranges (e.g., the average size of the pores within the plurality of pores may be between 1 micron and 100 microns).

The size of a pore may be determined using scanning electron microscopy.

As noted above, a porous, wettable, free-standing material may comprise sample holes in addition to pores. The sample holes may pass through the porous, wettable, free-standing material from one surface to an opposing surface. In some embodiments, the sample holes are larger than pores that are also present in a porous, wettable, free-standing material. For instance, the sample holes may have diameters larger than the sizes of the pores and/or may have an average diameter that is larger than the average diameter of the pores. In some embodiments, the sample holes have a diameter of greater than or equal to 0.71 mm.

A variety of suitable porous, wettable, free-standing materials may be employed in the sample control covers described herein. In some embodiments, a porous, wettable, free-standing material is fibrous (i.e., comprises fibers). The fibers may take the form of a woven or non-woven fiber web. Non-limiting examples of suitable porous, wettable, free-standing material that is fibrous include papers (e.g., blotting papers, cellulose-based papers), felts, and the sides of hook-and-loop fasteners (e.g., the hook side, the fastener side, a hook-and-loop fastener that is mated together).

In some embodiments, a porous, wettable, free-standing material comprises, consists essentially of, and/or consists of a foam, such as an open-cell foam. Suitable foams may comprise, consist essentially of, and/or consist of polymers (e.g., elastomers, rubber, plastics) and/or metals. In some embodiments, a porous, wettable, free-standing material comprises, consists essentially of, and/or consists of a sponge.

The porous, wettable, free-standing materials described herein may comprise synthetic materials, natural materials, or both synthetic and natural materials. One example of a porous, wettable, free-standing material that is a natural material is wood.

In some embodiments, a porous, wettable, free-standing material comprises a component that indicates whether it is wet with a liquid and/or the degree to which it is wet with a liquid. For instance, such a material may comprise a component that changes color upon wetting to a certain degree and/or that has a color indicative of the amount of fluid with which it is wet. One non-limiting example of such a component is a moisture-sensitive dye.

In some embodiments, a porous, wettable, free-standing material comprises a dye that is soluble in a fluid (e.g., water) with which the porous, wettable, free-standing material is to be wet. Such a dye may initially be present on one or more surfaces within the porous, wettable, free-standing material and/or at one or more depths below such a surface. Upon wetting by the fluid in which it is soluble, the dye may become diluted and/or may be transported through the porous, wettable, free-standing material with the fluid. Such dyes may therefore be employed to provide a visual signal as to the degree to which the porous, wettable, free-standing material has been wet and/or to locations within the porous, wettable, free-standing material that have been wet.

Other embodiments of the present invention will be apparent to one skilled in the art. As such, the foregoing description merely enables and describes the general uses and methods of the present invention. Accordingly, the following claims define the true scope of the present invention.

1. An evaporation control cover for use with a multi-well sample tray comprising a plurality of sample wells, comprising:
a porous, wettable, free-standing material, wherein:
the porous, wettable, free-standing material comprises a plurality of pores,
the porous, wettable, free-standing material comprises one or more sample holes,
the one or more sample holes are arranged such that, when the evaporation control cover is in use, each sample well is beneath and vertically accessible by a sample hole, and
the sample hole or holes are larger than the pores.

2. An evaporation control cover for use with a multi-well sample tray comprising a plurality of sample wells, comprising:
a porous, wettable, free-standing material, wherein:
the porous, wettable, free-standing material comprises a plurality of pores,
the porous, wettable, free-standing material comprises a plurality of sample holes arranged to correspond to the sample wells, and
the sample holes are larger than the pores.

3. (canceled)

4. The evaporation control cover of claim 1, wherein the one or more sample holes are arranged to correspond to the sample wells.

5. The evaporation control cover of claim 1, wherein the porous, wettable, free-standing material comprises at least one sample hole that, when the evaporation control cover is in use, two or more sample wells are therebeneath and are vertically accessible thereby.

6. The evaporation control cover of claim 1, wherein the porous, wettable, free-standing material comprises at least one sample hole that, when the evaporation control cover is in use, exactly one sample well is therebeneath and vertically accessible thereby.

7. The evaporation control cover of claim 1, wherein the porous, wettable, free-standing material includes exactly one sample hole that all the sample wells are therebeneath and vertically accessible thereby.

8. The evaporation control cover of claim 1, wherein the porous, wettable, free-standing material includes the same number of sample holes as sample wells, and wherein the sample holes arranged to correspond to the sample wells.

9. The evaporation control cover of claim 1, wherein the porous, wettable, free-standing material comprises at least one sample hole that extends to an edge of a central body portion.

10-11. (canceled)

12. The evaporation control cover of any preceding claim 1, wherein the porous, wettable, free-standing material comprises one or more flanges.

13. (canceled)

14. The evaporation control cover of claim 12, wherein the flange and/or flanges have a shape that mates with a portion of the multi-well sample tray.

15. The evaporation control cover of claim 12, wherein the flange and/or flanges have a shape that fits around the multi-well sample tray.

16-17. (canceled)

18. The evaporation control cover of claim 12, wherein the sample holes are positioned on a central body portion of the evaporation control cover, and wherein the flange and/or flanges are integrally connected to the central body portion.

19. The evaporation control cover of claim 12, wherein the sample holes are positioned on a central body portion of the evaporation control cover, and wherein the flange and/or flanges are positioned on opposing sides of fold(s) in the porous, wettable, free-standing material from the central body portion.

20. (canceled)

21. The evaporation control cover of claim 1, wherein the porous, wettable, free-standing material comprises one or more ribs.

22. (canceled)

23. The evaporation control cover of claim 21, wherein the rib and/or ribs extend through the thickness of the porous, wettable, free-standing material.

24. The evaporation control cover of claim 21, wherein the rib and/or ribs project upwards from the rest of the evaporation control cover.

25. The evaporation control cover of claim 1, wherein the porous, wettable, free-standing material comprises one or more embossments.

26. (canceled)

27. The evaporation control cover of claim 25, wherein the embossment and/or embossments extend through the thickness of the porous, wettable, free-standing material.

28. The evaporation control cover of claim 25, wherein the embossment and/or embossments project downwards from the rest of the evaporation control cover.

29-32. (canceled)

33. The evaporation control cover of claim 1, wherein the porous, wettable, free-standing material comprises one or more tabs.

34. (canceled)

35. The evaporation control cover of claim 33, wherein the tab and/or tabs have a shape that mates with a portion of the multi-well sample tray.

36-37. (canceled)

38. The evaporation control cover of claim 1, wherein the porous, wettable, free-standing material comprises a lip.

39-40. (canceled)

41. The evaporation control cover of claim 1, wherein the plurality of pores has a morphology that promotes the flow of liquid thereinto via capillarity.

42-43. (canceled)

44. The evaporation control cover of claim 1, wherein the pores have an average size of greater than or equal to 1 micron and less than or equal to 100 microns.

45-49. (canceled)

50. The evaporation control cover of claim 1, wherein the pores comprise pores that form a network that spans the porous, wettable, free-standing material.

51. The evaporation control cover of claim 1, wherein the porous, wettable, free-standing material is a paper, an open-cell foam, a felt, a sponge, or wood.

52-59. (canceled)

60. The evaporation control cover of claim 1, wherein a coating is disposed on a surface of the porous, wettable, free-standing material, and wherein the coating acts as a barrier to vapor transport through the evaporation control cover.

61-64. (canceled)

65. The evaporation control cover of claim 60, wherein the coating is a wax.

66-87. (canceled)
